(19) United States
(12) Patent Application Publication
(10) Pub. No.: US 2025/0244967 A1
(43) Pub. Date: Jul. 31, 2025

(54) SYSTEMS AND METHODS FOR USING GENERATIVE ARTIFICIAL INTELLIGENCE (AI) TO GENERATE COMPUTER CODE AND STRUCTURED DATA

(71) Applicant: Express Scripts Strategic Development, Inc., St. Louis, MO (US)

(72) Inventors: Lakshmikumari Meerasankaranarayanan, Avon, CT (US); Chakravarthy B. Metturdharma, Avon, CT (US); Andy Fanning, Jefferson City, MO (US)

(21) Appl. No.: 18/946,471

(22) Filed: Nov. 13, 2024

Related U.S. Application Data
(60) Provisional application No. 63/626,090, filed on Jan. 29, 2024.
(60) Provisional application No. 63/548,304, filed on Nov. 13, 2023.

(51) Int. Cl. G06F 8/35

(52) U.S. Cl. CPC G06F 8/35

(57) ABSTRACT

Apparatuses, systems, and methods relate to technology to identify an input request associated with a plurality of automatic processes, pre-process, with a first machine learning model, user data associated with the input request to generate first executable program code and a first data structure containing a part of the user data, and generate an output to execute the first executable program code based on the first data structure and the input request. The technology can further select a first automatic process from the plurality of automatic processes based on the output, and execute the first automatic process based on the first automatic process being selected.

### CROSS-REFERENCE TO RELATED APPLICATIONS

This application is a non-provisional application and claims priority to U.S. Provisional Patent Application No. 63/626,090, filed on Jan. 29, 2024, and U.S. Provisional Patent Application No. 63/548,304, filed on Nov. 13, 2023. The entire disclosures of each of the above applications are incorporated herein by reference.

### TECHNICAL FIELD

Embodiments of the subject matter described herein relate generally to the use of generative artificial intelligence (AI). More particularly, embodiments of the subject matter relate to using at least one form of generative AI to generate computer code and structured data in executing automatic processes.

### BACKGROUND

Computing systems have become increasingly complex and sophisticated. Correspondingly, the workloads, reliance and trust in computing systems has increased. For example, computing systems can store and operate on different types of sensitive data and support numerous distinct technologies. Furthermore, computing systems routinely execute automated actions.

### BRIEF SUMMARY

Some embodiments of the present disclosure provide a system for using Generative Artificial Intelligence (AI) tools in claims adjudication applications. The system includes system memory components; communication components configured to transmit and receive data communication messages over a network; and at least one processor communicatively coupled to the system memory components and the communication components. The at least one processor is configured to: obtain a current input claim associated with claims adjudication, via the communication components; pre-process one or more contracts associated with the current input claim, to generate one or more pre-processed contracts, wherein the one or more contracts includes at least one of: a provider service agreement and a customer benefits summary; extract a subset of contract data from the one or more pre-processed contracts; extract claim data from the current input claim; use one or more Generative AI tools to generate an output result associated with adjudicating the current input claim, based on the subset of data and the claim data; and obtain the output result from the one or more Generative AI tools, via the communication components.

Some embodiments of the present disclosure provide a method for using Generative Artificial Intelligence (AI) tools in claims adjudication applications. The method obtains a current input claim associated with claims adjudication, by a primary computing device via communication components; pre-processes one or more contracts associated with the current input claim, by the primary computing device, to generate one or more pre-processed contracts, wherein the one or more contracts includes at least one of: a provider service agreement and a customer benefits summary; extracts a subset of contract data from the one or more pre-processed contracts, by the primary computing device; extracts relevant data from the current input claim, by the primary computing device; uses one or more Generative Artificial Intelligence (AI) tools to generate an output result associated with adjudicating the current input claim, based on the subset of data and the relevant claim data; and obtains the output result from the one or more Generative AI tools, by the primary computing device via the communication components.

In another embodiment, the system ingests unstructured data files from a database. The system parses the unstructured file to derive rules. While there may be multiple unstructured files, the resulting derived rules may be different from each unstructured data file. The system can automatically code rules for data processing from the derived rules. The code can be used to process incoming data files, e.g., claim files, for each claim. The claim can be dependent on the derived rules and the individual claim. In a further example, the set of derived rules are for a single benefit plan that is represented by a single unstructured data file. The use of the code from the automatically derived rules provides for a complete audit trail of processing the incoming data file using the code.

In some aspects, the techniques described herein relate to a computing system for including: a processor; and a memory having a set of instructions, which when executed by the processor, cause the computing system to: identify an input request associated with a plurality of automatic processes; pre-process, with a first machine learning model, user data associated with the input request to generate first executable program code and a first data structure containing a part of the user data; generate an output to execute the first executable program code based on the first data structure and the user request; select a first automatic process from the plurality of automatic processes based on the output; and execute the first automatic process based on the first automatic process being selected.

In some aspects, the techniques described herein relate to a method including: identifying an input request associated with a plurality of automatic processes; pre-processing, with a first machine learning model, user data associated with the input request to generate first executable program code and a first data structure containing a part of the user data; generating an output by executing the first executable program code based on the first data structure and the user request; selecting a first automatic process from the plurality of automatic processes based on the output; and executing the first automatic process based on the first automatic process being selected.

In some aspects, the techniques described herein relate to at least one non-transitory computer readable storage medium including a set of instructions, which when executed by a computing system, cause the computing system to: identify an input request associated with a plurality of automatic processes; pre-process, with a first machine learning model, user data associated with the input request to generate first executable program code and a first data structure containing a part of the user data; generate an output to execute the first executable program code based on the first data structure and the user request; select a first automatic process from the plurality of automatic processes based on the output; and execute the first automatic process based on the first automatic process being selected.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a system for using generative artificial intelligence (AI) tools in claims adjudication applications, in accordance with the disclosed embodiments.

FIG. 2 is a functional block diagram of a primary computing device, in accordance with the disclosed embodiments.

FIG. 3 is a diagram of communications in a system for using generative AI tools in claims adjudication applications, in accordance with the disclosed embodiments.

FIG. 4 is an example database that may be deployed within the system of FIG. 1, according to some examples.

FIG. 5 is a functional block diagram of an example neural network that can be used for artificial intelligence engines or other functions as described herein to produce a predictive model for processing incoming data files.

FIG. 6 is a flow chart that illustrates an embodiment of a process for using generative AI tools in claims adjudication applications, according to the disclosed embodiments.

FIG. 7 is a flow chart that illustrates an embodiment of a process for pre-processing a contract, according to the disclosed embodiments.

FIG. 8 is a flow chart that illustrates an embodiment of a process for extracting a subset of data from a pre-processed contract, according to the disclosed embodiments.

FIG. 9 is a flow chart that illustrates an embodiment of a process for using a generative AI tool to perform claims adjudication, according to the disclosed embodiments.

FIG. 10 is a flow chart that illustrates an embodiment of a process for using a generative AI tool to dynamically generate executable instructions for performing claims adjudication, according to the disclosed embodiments.

FIG. 11 is a functional block diagram of a system for automatically generating code from unstructured data files to be used to process individual claim files.

FIG. 12 is a diagram of an example of a previous architecture and enhanced processing system according to an example.

FIG. 13 is a diagram of an example of a claims adjudication process according to an example.

FIG. 14 is a block diagram of an example patient management platform that may be deployed within the system of FIG. 1, according to some examples.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Computing implementations and software are extremely common and pervasive. Software can be used extensively across different aspects of a person's daily life, businesses, education, healthcare, entertainment, and more. Applications on smartphones, computing devices and tablets provide specialized and customized software powering large-scale business operations. Furthermore, appliances and other devices, such as automobiles, ovens, dishwashers, clocks, garage doors, etc., have embedded software systems. That is, software is fundamental to modern technology.

The widespread adoption of software has resulted in digital transformation, the rise of mobile devices, cloud computing, and increased automation. It enables efficiency, connectivity, and innovation, making software an invaluable asset in almost every sector and industry.

As mentioned above, entities (e.g., corporations, hospitals, insurance companies, doctors, patients, etc.) use software extensively across a myriad of operations. Software solutions play a critical role in areas like communication, data management, financial operations, customer relationship management (CRM), supply chain management, project management, and cybersecurity. Companies often rely on tailored software tools to streamline processes, enhance productivity, make data-driven decisions, and gain a competitive edge.

Complications can arise in existing software implementations. For example, software is routinely built on top of existing platforms, meaning that software can become quickly complicated and difficult to understand. For example, changes in a first application can have a cascade effect for all downstream applications such that errors can be generated in other applications by the change in the first application. Moreover, determining bugs in multiple applications can become problematic as it is not entirely clear where an error originates, and which application should be de-bugged. Furthermore, having multiple applications can increase bandwidth (e.g., application one transmits data to application two and/or transmits the data to a storage), processing power (multiple applications executed over limited computing resources) and memory usage and/or storage space the applications (e.g., several applications can consume significant storage space, application one stores an output in a storage for application two to access at a later time, etc.). Furthermore, updating multiple applications every time there is a modification or adjustment to a parameter (e.g., requirements for authentication modifications, standard-of-service changes, contractual adjustments, changes to automatic operation, navigation updates in a mapping processing, etc.) can become extremely complicated and time consuming, as well as error prone. Furthermore, doing so is impossible in real-time, taking weeks or months to complete.

As a consequence, entities (e.g., software developers) can be constrained by limitations in core platforms, meaning that the core platforms are rigid and the entities have difficulty making changes to the core platforms. Doing so prevents the entities from offering new innovative products and the life cycle for bringing in a new product is very long. For example, generating a new innovative product can include changing all the applications associated with an automatic process and also the business processes all the way up to the core platforms. Furthermore, the time and the cost to develop new products is quite high because the entities, even for a small change, have to traverse all the way from the beginning to the end of a computing platform (including several applications) to make adjustments. This cumbersome process therefore stifles potential innovations. Programmers can consider the massive undertaking to implement a modification and consequently determine that the reward on implementing such changes are outweighed by the amount of work involved with the change.

Furthermore, duplicative systems exist to install operations for a client (e.g., a computer or software application that requests and receives services or information from a server). To do so, existing implementations install the client in three or four different applications all along the way. For example, the client is installed into application one from which data flows to application two, application three, and then other applications. To do so, some additional pieces of elements of the data is set up in application two and then data flows from application one and then application two, application three and then a final core administration platform. The amount of setup and the time involved in setting up all these applications is quite large, error prone and duplicative as well. Further, significant communication (e.g., back and forth) occurs to transfer data. Moreover, data inconsistencies can occur. For example, application one may not mirror the data of application two and there may be loss of information, etc. Finally, the setup of the client can be based on policies, and in some cases the applications execution does not match the policies (e.g., impedance mismatch) due to mis-programming or updates to the policies.

Examples herein remedy the above through innovative and new machine learning models that implement changes in real-time and on the fly. The machine learning models can streamline the multiple applications mentioned above and generate computer executable code to implement the automatic processes described herein. Doing so can reduce the amount of code (e.g., multiple applications containing redundant code can be eliminated) to reduce memory, reduce bandwidth (communication between applications is eliminated), reduce processing power (multiple large sized applications are not executed, rather just one streamlined compute executable code set can be executed) and can execute updates with reduced latency (the machine learning model can generate code in near real-time or real-time). Furthermore, consistency is achieved by having the machine learning model (e.g., artificial intelligence or AI) generate code rather than process the claims to reduce impacts of hallucinations and errors.

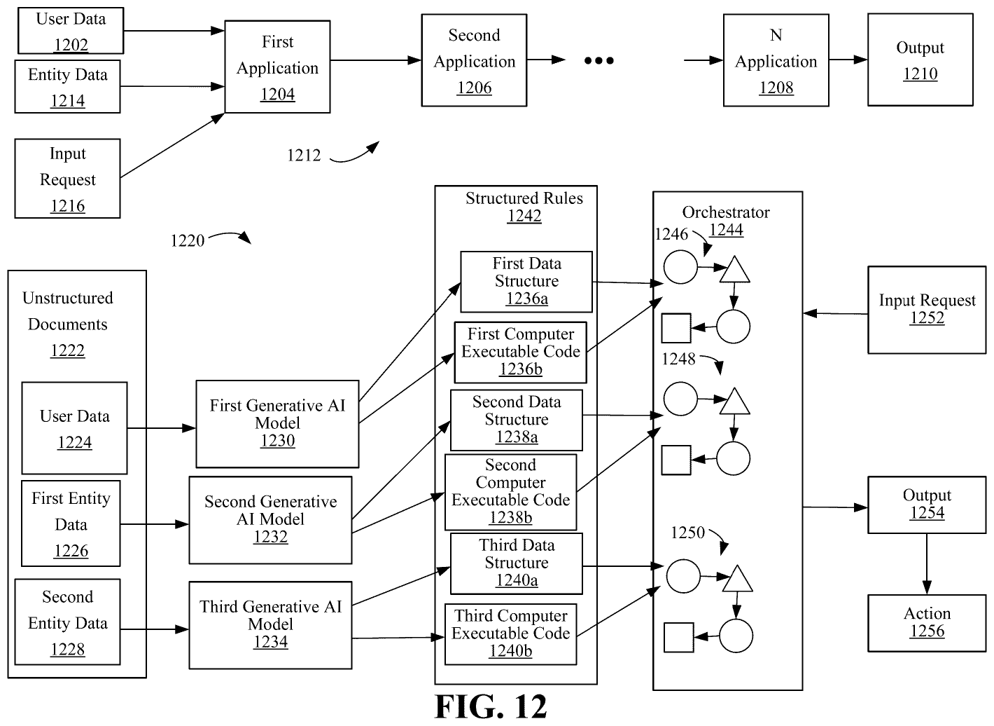

Turning now to FIG. 12, a previous architecture 1212 is illustrated. The previous architecture is sub-optimal for many of the reasons stated above with respect to the existing software implementations. For example, a first application 1204 receives user data 1202, entity data 1214 and input request 1216. The user data 1202 can be associated with a user and include user specific data (e.g., user contract details with the entity, personal information, address, user specific selections such as online security preferences, multi-factor authentication, health insurance agreement, home insurance agreement, etc.). The entity data 1214 can be associated with an entity and include details specific to the entity (e.g., agreements of entity, agreements of a provider with an entity such as health insurance, quality-of-service agreements, third-party contract details with an entity, entity capabilities, entity restrictions, etc.) that are to be conformed to when performing services on behalf of the user. The entity can be tasked with executing an operation on behalf of the user mentioned above. The input request 1216 can be a request to execute a specific automated action (e.g., process a medical claim submitted by a provider for the user, process a change to an account of the user, login to the user account, ship a package to the user, etc.).

Details of the user data 1202, entity data 1214 and input request 1216 can be manually provided to the first application 1204 and/or the second application 1206-N application 1208. That is, a user can manually provide the details to process a request. Doing so is error prone, lengthy and constrained by human abilities. In some examples, different ones of the first application 1204-N application 1208 contain different aspects of the user data 1202 and/or the entity data 1214. For example, the first application 1204 can contain a first subset of the user data 1202 while the second application 1206 can contain a second subset of the user data 1202, where the first and second subsets of the user data 1202 are different from each other. In some examples, the first application 1204 can contain a first subset of the entity data 1214 while the second application 1206 can contain a second subset of the entity data 1214, where the first and second subsets of the entity data 1214 are different from each other. Thus, the user data 1202 and the entity data 1214 are distributed through numerous different software applications and creates a disorganized storage of information, sub-optimal efficiency, limited throughput (e.g., more processing power needed to run many different applications of the first application 1204-N application 1208). Moreover, if the user data 1202 and/or the entity data 1214 is updated, numerous different applications from the first application 1204-N application 1208 will be updated increasing down time and the effort to execute any changes.

The first application 1204 can generate an output and provide the output to the second application 1206, then to a third application (not illustrated) and so on until an N application 1208 receives an output from an N−1 application (not illustrated). One or more of the second application 1206-N application 1208 can receive one or more of the user data 1202, entity data 1214 or input request 1216 in some examples. The output 1210 can be a decision of whether to authorize and execute the specific automated action, or deny the specific automated action.

As noted above, in the previous architecture 1212 complications can arise since new applications are routinely built on top of existing applications, meaning that software can become quickly complicated and difficult to understand. For example, changes in the first application 1204 can have a cascade effect for all downstream applications such as second application 1206-N application 1208. As a result, changes in the first application 1204 can generate errors in the second application 1206-N application 1208. Moreover, determining bugs in the first application 1204-N application 1208 can become problematic as it is not entirely clear where an error originates, and which application should be de-bugged. Furthermore, having first application 1204-N application 1208 (multiple applications) can increase bandwidth (e.g., first application 1204 transmits data to second application 1206 and/or stores the data in a storage), processing power (multiple applications executed over limited computing resources) and memory usage to store outputs from the multiple applications (e.g., first application 1204 stores an output in a storage for second application 1206 to access at a later time). Furthermore, updating the multiple applications every time there is a modification or adjustment to a parameter (e.g., requirements for authentication modifications, standard-of-service changes, contractual adjustments, changes to automatic operation, navigation updates in a mapping processing, etc.) in the user data 1202 and entity data 1214 can become extremely complicated and time consuming, as well as error prone. Furthermore, doing so is impossible in real-time, taking weeks or months to complete.

As a consequence and as mentioned above, entities can be constrained by limitations in core platforms, meaning that the core platforms are rigid and the entities have difficulty making changes to the core platforms. Doing so prevents the entities from offering new innovative products and the life cycle for bringing in a new product is very long. The entities can change all the first application 1204-N application 1208 and any business processes all the way up to the core platforms to offer any new innovative products. Furthermore, the time and the cost to experiment with coming out with new products is large because the entities, even for a small change, have to traverse all the way from the beginning to the end of a computing platform, including first application 1204-N application 1208 to make adjustments. The cumbersome process stifles potential innovations, and limits programmers (e.g., programmers can consider the massive undertaking to implement a modification and consequently determine that the reward on implementing such changes is outweighed by the amount of work involved with the change). Furthermore, as mentioned above, duplicative systems exist to install operations for a client (e.g., a computer or software application that requests and receives services or information from a server) leading to complications. Moreover, data inconsistencies can occur as mentioned above.

Turning now to enhanced processing system 1220, an enhanced platform to remedy the above drawbacks of previous architecture 1212 is described. The enhanced processing system 1220 includes innovative and new machine learning models embodied as a first generative artificial intelligence model 1230, a second generative artificial intelligence model 1232 and a third generative artificial intelligence model 1234 that implement changes in real-time and on the fly. The machine learning models can omit the multiple applications (first application 1204-N application 1208) mentioned above and generate computer executable code to implement the automatic processes described herein. Doing so can reduce the amount of code (e.g., multiple applications containing redundant code for clients can be eliminated) to reduce memory, reduce bandwidth (communication between applications is eliminated), reduce processing power (multiple large sized applications are not executed, rather just one streamlined compute executable code set can be executed) and can execute updates with reduced latency (the machine learning model can generate code in near real-time or real-time).

Enhanced processing system 1220 includes unstructured documents 1222. The unstructured documents 1222 includes user data 1224, first entity data 1226 associated with a first entity and second entity data 1228 (can be associated with the first entity or another entity). The first generative artificial intelligence model 1230. The user data 1224 can be user specific data (e.g., user contract details with the entity, personal information, address, user specific selections such as online security preferences, multi-factor authentication, health insurance agreement, home insurance agreement, etc.).

The first entity data 1226 can be associated with the first entity and include details specific to the first entity (e.g., agreements of first entity, agreements of a provider with the first entity such as health insurance, quality-of-service agreements, third-party contract details with the first entity, first entity capabilities, first entity restrictions, etc.) that are to be conformed to when the first entity performs services on behalf of the user. The first entity can be tasked with executing an operation on behalf of the user mentioned above. The operation can be requested in input request 1252. The input request 1252 can be a request to execute a specific automated action (e.g., process a medical claim submitted by a provider for the user, process a change to an account of the user, login to the user account, ship a package to the user, etc.) associated with the user and the first entity (first entity executes the automated action).

The second entity data 1228 can include further data related to procedures and parameters of the first entity and/or a second entity (e.g., a medical policy, standard of policy, etc.) in some examples, the user data 1224, the first entity data 1226 and the second entity data 1228 can each be a different document that describe different parameters, contracts and/or standard-of-service. In some examples, the second entity can be distinct from the first entity and assists in executing the operations on behalf of the user.

In some examples, the second entity data 1228 can be omitted. In some examples, the user data 1224 can include a user preference, user requirement (e.g., use multi-factor authentication, restrict purchases to $20 or less, overnight delivery preferred, etc.), while the first entity data 1226 can include constraints (e.g., overnight delivery impossible for certain items, need for signing, contracts, etc.) or entity preferences. That is, the user data 1224 and the first entity data 1226 are flexible in nature, but relate to different constraints of the user, the first entity and/or the second entity.

The first generative artificial intelligence model 1230, second generative artificial intelligence model 1232, third generative artificial intelligence model 1234, structured rules 1242 and orchestrator 1244 can be under the control of a third entity (e.g., insurance provider, internet security provider, information technology group, etc.). The third entity can determine whether to authorize and/or permit a requested operation in the input request 1252 or decline the operation.

The first generative artificial intelligence model 1230 pre-processes the user data 1224 and generates a first data structure 1236a and a first computer executable code 1236b. The first generative artificial intelligence model 1230 receives the user data 1224, and extracts the user data 1224 into two parts. The first data structure 1236a is the structured data to take all the structured information from the user data 1224 (filters and does not include unstructured data) and converts the structured information into a structured data represented as the first data structure 1236a. The first generative artificial intelligence model 1230 can also extract rules from the user data 1224 (e.g., user preferences, contractual obligations, etc.), and convert the rules into the first computer executable code 1236b.

The first data structure 1236a can include relevant details from the user data 1224 such as user age, demographic data, multi-factor authentication options, account preferences, address, medical benefit information, etc. The first computer executable code 1236b can include programming code (e.g., JavaScript Object Notation, Python, etc.) that when executed, causes a computing device to generate an output (e.g., a decision of whether to authorize an action or decline an action or the operation) based on the rules defined in the user data 1224. The action (also referred to as the operation) can be specified in the input request 1252.

The second generative artificial intelligence model 1232 can pre-process the first entity data 1226 to generate a second data structure 1238a and a second computer executable code 1238b. The second generative artificial intelligence model 1232 receives the first entity data 1226, and extracts the first entity data 1226 into two parts. The second data structure 1238a is the structured data to take all the structured information from the second entity data 1228 (filters and does not include unstructured data), and converts the structured information into structured data represented as the second data structure 1238a. The second generative artificial intelligence model 1232 can also extract rules from the first entity data 1226 (e.g., first entity preferences, first entity constraints, contractual obligations, etc.), and convert the rules into the second computer executable code 1238b.

The second data structure 1238a can include relevant details from the first entity data 1226 such as provider reimbursement amounts, terms and conditions for providing and reimbursing healthcare services, restrictions on the deliveries of certain items, etc. The second computer executable code 1238b can include programming code (e.g., JavaScript Object Notation, Python, etc.) that when executed, causes a computing device to generate an output (e.g., a decision of whether to authorize an action or decline the action) based on the rules defined in the first entity data 1226. The action can be specified in the input request 1252.

Similar to above, the third generative artificial intelligence model 1234 receives the second entity data 1228. The third generative artificial intelligence model 1234 can generate a third data structure 1240a and a third computer executable code 1240b based on the second entity data 1228. The third data structure 1240a is the structured data to take all the structured information from the second entity data 1228 (filters and does not include unstructured data), and converts the structured information into structured data represented as the third data structure 1240a. The third generative artificial intelligence model 1234 can also extract rules from the second entity data 1228 (e.g., entity preferences, entity constraints, contractual obligations, etc.), and convert the rules into the third computer executable code 1240b.

The third data structure 1240a can include relevant details from the second entity data 1228 such as provider reimbursement amounts, terms and conditions for providing and reimbursing healthcare services, restrictions on the deliveries of certain items, etc. The third computer executable code 1240b can include programming code (e.g., JavaScript Object Notation, Python, etc.) that when executed, causes a computing device to generate an output (e.g., a decision of whether to authorize an action or decline an action) based on the rules defined in the second entity data 1228. The action can be specified in the input request 1252.

In this example, an orchestrator 1244 can generate an output (e.g., final decision) based on the input request 1252, first data structure 1236a, first computer executable code 1236b, second data structure 1238a, second computer executable code 1238b, third data structure 1240a and third computer executable code 1240b. The orchestrator 1244 can receive the input request 1252 and determine which sets of code from the first computer program 1246, second computer program 1248 and third computer program 1250 to execute based on the input request 1252. Thus, in some examples, not all of the first computer program 1246, second computer program 1248 and third computer program 1250 are executed to process the input request 1252. Doing so can reduce processing power, reduce latency, and reduce memory usage.

The orchestrator 1244 can execute the first computer executable code 1236b based on data from the first data structure 1236a and the input request 1252. For example, the first computer executable code 1236b can include variables and/or constant values that are set based on values in the first data structure 1236a (e.g., if user authorized multi-factor authentication a variable can be set to one, or a payment authorization amount for the user, etc.). Variables and/or constant values of the first computer executable code 1236b can further be set based on values in the input request 1252. The first computer executable code 1236b with the values from the first data structure 1236a and the input request 1252 is represented as first computer program 1246.

The orchestrator 1244 can execute the second computer executable code 1238b based on data from the second data structure 1238a and the input request 1252. For example, the second computer executable code 1238b can include variables and/or constant values that are set based on values in the second data structure 1238a (e.g., if first entity can execute authorized multi-factor authentication a variable can be set to one, or a payment authorization amount for a provider, etc.). Variables and/or constant values of the second computer executable code 1238b can further be set based on values in the input request 1252. The second computer executable code 1238b with the values from the second data structure 1238a and the input request 1252 is represented as second computer program 1248.

The orchestrator 1244 can execute the third computer executable code 1240b based on values from the third data structure 1240a and the input request 1252. For example, the third computer executable code 1240b can include variables and/or constant values that are set based on data in the third data structure 1240a. Variables and/or constant values of the third computer executable code 1240b can further be set based on values in the input request 1252. The third computer executable code 1240b with the values from the third data structure 1240a and the input request 1252 is represented as third computer program 1250.

In some examples, the first computer program 1246, second computer program 1248 and the third computer program 1250 are linked together. For example, values generated from the first computer program 1246 can be provided to the second computer program 1248 and/or the third computer program 1250, as well as vice versa. Similarly, values generated from the second computer program 1248 can be provided to the third computer program 1250 and the first computer program 1246, etc.

The orchestrator 1244 can generate an output 1254 based on the execution of the first computer program 1246, second computer program 1248, and the third computer program 1250. For example, the output 1254 can be an indication whether the requested action (e.g., login into an account, payment for services, etc.) should be executed or not. In this example, the output 1254 indicates that the action should be performed, and therefore action 1256 is executed. In other examples, the output 1254 can indicate that a different action should be executed (e.g., deny processing of the claim and/or payment), in which case the action 1256 can be a notification of the denial of the benefit and/or payment. That is, enhanced processing system 1220 can select a first automatic process (the action 1256) from a plurality of automatic processes (e.g., deny payment of the claim, pay the claim, automatic rejection of the claim, an automatic acceptance of the claim, etc.) based on the output.

In some examples, the input request 1252 can be a request to execute a specific first automated action (e.g., process a medical claim submitted by a provider for the user, process a change to an account of the user, login to the user account, ship a package to the user, etc.). In which case the action 1256 can be the first automated action itself if the output 1254 indicates that the first automated action is allowed, or a second automated action denying the first automated action.

If there is an update to the user data 1224, the first generative artificial intelligence model 1230 can be re-executed based on the updated user data 1224 and execute in real-time. Accordingly, the first data structure 1236a and the first computer executable code 1236b can be updated in real-time to reflect any changes. Similarly, the second generative artificial intelligence model 1232 and the third generative artificial intelligence model 1234 can be re-executed based on any updates to the first entity data 1226 and the second entity data 1228 respectively to update the second data structure 1238a, second computer executable code 1238b, third data structure 1240a and third computer executable code 1240b.

The enhanced processing system 1220 can provide significant enhancements relative to the previous architecture 1212. For example, the enhanced processing system 1220 can provide repeatability, auditability and traceability for core systems. Furthermore, the repeatability, auditability and traceability of the enhanced processing system 1220 can provide enhancements relative to traditional generative AI applications that suffer from hallucinations and inconsistency. That is, producing first computer program 1246, second computer program 1248 and third computer program 1250 with the first generative artificial intelligence model 1230, second generative artificial intelligence model 1232 and third generative artificial intelligence model 1234 is more reliable, consistent (a certain input will always provide a same output) for processing input requests (e.g., providing the input request directly to a generative AI model) than forming a decision with the generative AI model based on the input requests. That is, generative AI may produce inconsistent outputs based on the inputs. That is, different users can have a consistent output if the user data 1224, first entity data 1226 and second entity data 1228 are the same between the users.

Furthermore, the first data structure 1236a, second data structure 1238a and third computer executable code 1240b can be in JavaScript Object Notation (JSON) structured data and associated with the first computer executable code 1236b, second computer executable code 1238b and third computer executable code 1240b (e.g., Python code). Doing so permits customization at a granular level and using specific programming logic. The code generation of the first computer executable code 1236b, second computer executable code 1238b and third computer executable code 1240b will utilize a set of common, reusable modules that can be integrated into user-specific code. Doing so also leverages the speed and flexibility of generative AI to solve complex automation problems in a modern manner.

In some examples, the first generative artificial intelligence model 1230, second generative artificial intelligence model 1232 and third generative artificial intelligence model 1234 can be large language models that excel in generating structured outputs and code. Doing so leverages the speed and flexibility that generative AI technology has to offer while implementing customization at a micro-level.

Moreover, the orchestrator 1244 is a platform agnostic solution. The orchestrator 1244 can execute on in-house servers or public cloud infrastructure for example. Furthermore, the solution can be applied to other domains that have client policy documents (e.g., life, medical or home insurance policies) with client rules and policies embedded in the documents.

In some examples, the enhanced processing system 1220 can execute in a health insurance environment. In such a case, the user data 1224 is a client benefit summary, the first entity data 1226 are provider contracts and the second entity data 1228 can be a medical policy (Standard Operating Procedure).

The network(s) connecting the various components of enhanced processing system 1220 can include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

Aspects of the enhanced processing system 1220 can be implemented be implemented in logic instructions (e.g., software), configurable logic, fixed-functionality hardware logic, computer readable instructions stored on at least one non-transitory computer readable storage medium that are executable to implement aspects of enhanced processing system 1220, circuitry, etc., or any combination thereof. The enhanced processing system 1220 can be a computing architecture, in which any of the components are executed in logic instructions (e.g., software), configurable logic, fixed-functionality hardware logic, computer readable instructions stored on at least one non-transitory computer readable storage medium that are executable to implement on the enhanced processing system 1220, circuitry, etc., or any combination thereof.

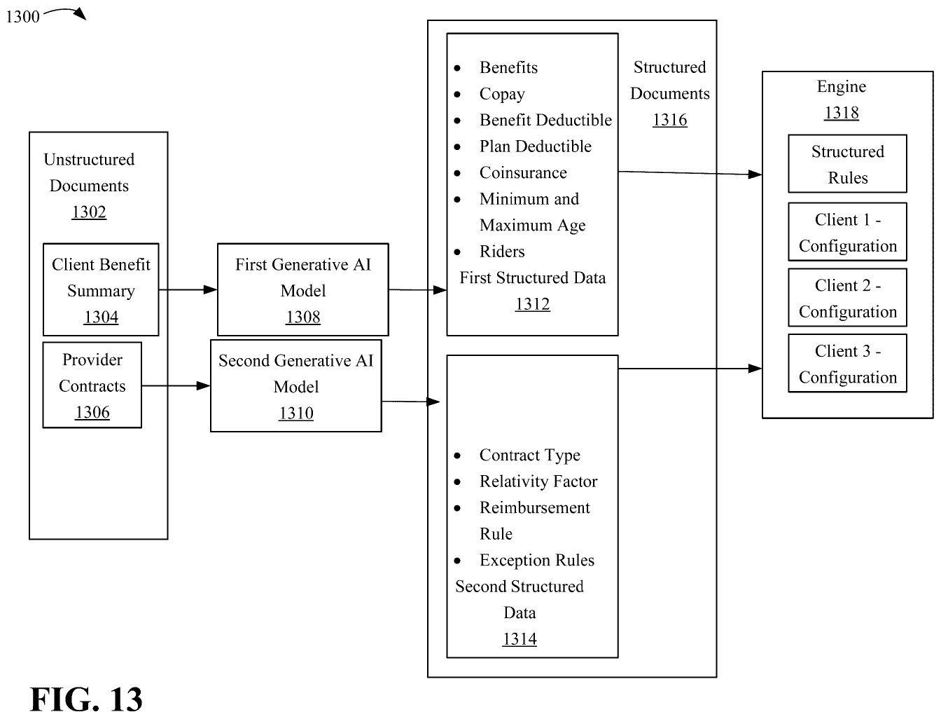

Turning now to FIG. 13, a claims adjudication process 1300 of the present application is illustrated in the context of health care insurance processing. It will be understood that while healthcare insurance processing is specifically described in claims adjudication process 1300, examples are not so limited. For example, examples can also be applied to authentication, account changes to a user profile, security enforcement for computing systems, automated deliveries and so forth. Examples can execute over any unstructured document(s) containing operations that are to be executed in a computing system.

The claims adjudication process 1300 can generally be implemented in conjunction with any of the embodiments described herein, for example the enhanced processing system 1220 (FIG. 12). In an embodiment, the claims adjudication process 1300 is implemented in logic instructions (e.g., software), configurable logic, fixed-functionality hardware logic, computer readable instructions stored on at least one non-transitory computer readable storage medium that are executable to implement claims adjudication process 1300, circuitry, etc., or any combination thereof.

In this example, unstructured documents 1302 include a client benefit summary 1304 (e.g., document that provides an overview of a health insurance plan's benefits and coverage), and provider contracts 1306 (e.g., describes arrangements between a healthcare provider (e.g. hospitals, clinics, or individual healthcare professionals) and a healthcare payer (e.g. insurance companies or government programs). The first generative AI model 1308 and second generative AI model 1310 can execute an algorithm through a series of prompts and actions.

The second generative AI model 1310 can identify a type of reimbursement. The presence of geographic practice cost index (GPCI) index in the provider contracts 1306 and the source-based relative value scale (RBRVS) (e.g., a system that determines how much money medical providers receive for their services scheduled references) is in the provider contracts 1306. The second generative AI model 1310 can identify that second structured data 1314 would follow the market standard and RBRVS logic, as well as structured rules. That is, the second generative AI model 1310 can generate the second structured data 1314 and identity the structured rules based on the GPCI index and the RBRVS index. Therefore, claims processing based on the second structured data 1314 will comply with the RBRVS and the GPCI index.

A second step can include extraction of the base relativity factor (e.g., market standard, provider specific, preferred schedule, etc.) from the provider contracts 1306 (e.g., contract document). A third step can include calculating a base fee schedule for the GCPI location (e.g., Colorado) and RBRVS year (e.g., year 2020) using the information in the provider contracts 1306 (e.g., fee schedule system, Centers for Medicare and Medicaid Services, etc.). A fourth step can include multiplying by the base relativity factor extracted from the second step to generate the final fee schedule that is part of the second structured data 1314 that is applicable for the services in the second structured data 1314.

Examples can also extract riders from the provider contracts 1306. Any pricing impacting terms such as exclusion services, exception reimbursement rules and reimbursement rules are extracted as riders. A reimbursement rule and covered services will be reimbursed at the lesser of billed charges or the RBRVS allowable fee, less applicable copayments, deductibles and coinsurance. An exception reimbursement rule includes all procedure codes for covered services for which reimbursement has not been established above, including but not limited to those for unlisted procedures as well as new Current Procedural Terminology (CPT), Healthcare Common Procedure Coding System (HCPCS) and/or American Society of Anesthesiologists (ASA) procedure codes, will be paid at a X % reduction from billed charges, less applicable copayments, deductibles and coinsurance, until such time as the applicable relative value units have been loaded into the appropriate claims systems.

Pseudocode I provided below illustrates an example of the structured rules:

Pseudocode I

```
/** Reimbursement Rule **/
def reimbursement_rule(rider_json: Dict, claim_obj: Dict) −> float:
  try:
    rules = rider_json[‘reimbursement_rule’]
    lesser_of_indicator = rules[‘lesser_of_indicator’]
    lesser_of_percent = float(rules[‘lesser_of_percent’])
```

| | |
|---|---|
| reduction_in_billed_charge_percentage | = |

```
rules[‘reduction_in_billed_charge_percentage’]
    billed_charges = claim_obj[‘billed_charges’]
    rbrvs_allowable_fee = claim_obj[‘rbrvs_allowable_fee’]
    if lesser_of_indicator == ‘Y’:
      if reduction_in_billed_charge_percentage != ‘null’:
```

| | |
|---|---|
| reduction_in_billed_charge_percentage | = |

float(reduction_in_billed_charge_percentage)

| | |
|---|---|
| billed_charges = billed_charges − (billed_charges | * |

reduction_in_billed_charge_percentage / 100)

| | |
|---|---|
| reimbursed_amount = min(billed_charges, rbrvs_allowable_fee) | * |

```
lesser_of_percent / 100
    else:
      reimbursed_amount = billed_charges
return reimbursed_amount
/** Reimbursement Rule **/
except Exception as e:
    print(f“An error occurred: {str(e)}”)
    return None
/**Exclusion Services**/
def exclusion_services(rider_json: Dict, claim_obj: Dict) −> float:
  try:
    exclusion_services_rules = rider_json[‘exclusion_services’]
    if claim_obj[‘procedureCode’] in exclusion_services_rules[‘service_name’]:
      if exclusion_services_rules[‘lesser_of_indicator’] == ‘Y’:
```

| | |
|---|---|
| reimbursement = max(claim_obj[‘billed_charges’] | * |

(float(exclusion_services_rules[‘lesser_of_percent’]) / 100),
claim_obj[‘rbrvs_allowable_fee’])
elif exclusion_services_rules[‘greater_of_indicator’] == ‘Y’:

| | |
|---|---|
| reimbursement = max(claim_obj[‘billed_charges’] | * |

```
(float(exclusion_services_rules[‘lesser_of_percent’]) / 100),
claim_obj[‘rbrvs_allowable_fee’] * (float(exclusion_services_rules[‘greater_of_percent’]) /
100))
      else:
        reimbursement = claim_obj[‘billed_charges’]
    else:
      reimbursement = claim_obj[‘billed_charges’]
      return reimbursement
Convert Riders to Code
except Exception as e:
    print(f“An error occurred: {e}”)
    return None
/** Exception Reimbursement Rule**/
def unrated_codes(rider_json: Dict, claim_obj: Dict) −> float:
  try:
```

| | |
|---|---|
| reduction_percentage | = |

rider_json[‘unrated_codes’][‘reduction_in_billed_charge_percentage’]
if reduction_percentage != ‘null’:

| | |
|---|---|
| reimbursement_amount = claim_obj[‘billed_charges’] * (1 | − |

```
float(reduction_percentage)/100)
    else:
      reimbursement_amount = claim_obj[‘billed_charges’]
    return reimbursement_amount
  except Exception as e:
    print(f“An error occurred: {str(e)}”)
  return None
```

The handling of professional, facility and ancillary pricing contract terms, variations reimbursement methodologies can be executed as described above. The second generative AI model 1310 can handle large contract documents with multiple exhibits by reliably splitting contents into smaller chunks. The second generative AI model 1310 can improve on the reliability of language model outputs by carefully receiving precise prompts (can be via an unillustrated machine learning model that extracts information from the provider contracts 1306 and provides the information to the second generative AI model 1310) and utilizing one-shot learning techniques. Additionally, examples can validate the responses from one language model by cross-checking with a secondary language model. Examples can also combine multiple current procedural terminology (CPT) codes together and make one large language model (LLM) call for the multiple CPT codes resulting in cost and time savings. Examples can also include “use of vision based LLMs” to understand pricing structure in complex tables (e.g., below, the $200/visit should be applied to all Therapies and not just Physical). Examples can Extract the grouper and rates from the provider contracts 1306, along with CPT and Revenue Code ranges as shown below:

TABLE I

| Outpatient Services | Coding | Reimbursement*** |
|---|---|---|
| Ambulatory Surgery - | Revenue Codes: 360, 361, | |
| Cigna Grouper | 369, 490, 499, 750, 790; | |
| Schedule* | CPT4 Codes: 10004-36299, | |
| Grouper 1 | 36420-69999, applicable | $2,569 Case Rate |
| Grouper 2 | CPT4 Category III surgical | $3,016 Case Rate |
| Grouper 3 | T codes, and applicable | $3,661 Case Rate |
| Grouper 4 | HCPCS surgery codes | $4,781 Case Rate |
| Grouper 5 | unless specified below. | $5,399 Case Rate |
| Grouper 6 | Note: only surgical | $5,483 Case Rate |
| Grouper 7 | CPT/HCPCS codes billed | $5,993 Case Rate |
| Grouper 8 | with these Revenue Codes | $6,631 Case Rate |
| Grouper 9 | will be reimbursed at the | $10,457 Case Rate |
| Default Rate ** | rates in this table. | $4,590 Case Rate |

Examples can further Extract Riders from the provider contracts 1306. Any pricing impacting terms such as exclusion services, exception reimbursement rules and reimbursement rules are extracted as riders. The following is Pseducode II for generating a code for riders:

Pseduocode II

```
def calculate reimbursement(procedure reimbursements):
  # Check if there are more than 3 procedures
  if len(procedure reimbursements) > 3:
    # If so, only the first three are reimbursed, others are ignored
    procedure reimbursements = procedure reimbursements[:3]
  # Initialize total reimbursement
  total reimbursement = 0
  # Loop through the procedures
  for index, reimbursement in enumerate(procedure_reimbursements):
    if index == 0:
      # The first procedure is reimbursed at 100%
      total reimbursement += reimbursement
    elif index == 1:
      # The second procedure is reimbursed at 50%
      total reimbursement += reimbursement * 0.5
    elif index == 2:
      # The third procedure is reimbursed at 25%
      total reimbursement += reimbursement * 0.25
    # Additional procedures are not reimbursed, so they are not included
  return total reimbursement
# Example usage:
# Suppose we have the following reimbursements for procedures in a single session
procedure reimbursements = [1500, 1200, 1000, 800, 600]
total = calculate reimbursement(procedure_reimbursements)
print(f“Total reimbursement for the surgical session: ${total}”)
```

The first generative AI model 1308 can generate first structured data 1312 and structured rules similarly to as described above. For example, examples can extract headers and identify network types (e.g., plan highlights, in-network costs, out-of-network costs, etc.) from the client benefit summary 1304. Additionally, the first generative AI model 1308 can extract the benefit service, sub service and copay deductible. Examples can further apply logic to map an incoming CPT code to the right benefit service. Using a combination of the CPT code, provider location, provider role, identify the right benefit, that applies for a CPT Code. The first generative AI model 1308 can extract riders, emergency services (e.g., the emergency room (ER) charges include ER, Physician, Lab and Radiology. Even if different claim lines and/or multiple CPT codes are present, this will be reimbursed as a single charge. This first generative AI model 1308 interprets this as a rider. The first generative AI model 1308 can further execute claims adjudication to require ‘medical definitions’ to map the incoming details from the claim to the benefits and thereby perform the cost sharing calculation.

Accordingly, the first generative AI model 1308 and the second generative AI model 1310 generate the first structured data 1312 and the second structured data 1314 o the structured documents 1316. The first generative AI model 1308 and the second generative AI model 1310 can also generate structured rules, client 1 configurations, client 2 configurations and client 3 configurations that is supplied to engine 1318.

Claims adjudication process 1300 includes a system and methods for data processing improvements related to claims adjudication. More specifically, the subject matter relates to use of Generative Artificial Intelligence (AI) tools to develop content from claims data or unstructured data files. The tools can automatically generate code to be used when adjudicating incoming claim files. For example, the code can be executable by a computing device to automatically perform one or more tasks to automatically process the incoming claim files and execute a payout or denial based on the incoming claim files. For example, the automatically generated code can include the fetching and/or completion of missing data from the claim files. Adjudicating a claim file can be the process of evaluating a claim to determine how much to reimburse a provider for a service. It can also refer to the legal process of settling a claim or dispute through the court system.

While some examples herein apply specifically to claims adjudication, it will be understood that the implementation can vary and apply to different industries and/or scenarios. For example, it is common to have errors, missing data and/or incomplete automatic processes. As one example, consider that automation can rely on sensor readings. If such automation lacks particular data (e.g., sensor data), the automatic processes may cease or operate ineffectively. Various technological areas can be included, such as communications, energy production, automatic home deliveries, prescription refills, etc.

Generative AI tools may include large language models or machine learning that uses algorithms to generate new content, code, or data relating to claims adjudication, within the context of the present disclosure. Generative AI tools can reside and run on a system of one or more computers configured to perform particular operations or actions by virtue of having software, firmware, hardware, or a combination thereof, installed on the system that, in operation, causes or cause the system to perform the actions. One or more computer programs can be configured to perform particular operations or actions by virtue of including instructions that, when executed by a data processing apparatus, cause the apparatus to perform the actions. Such programs run on dedicated circuitry.

A claim can refer to one or more data records (e.g., files) relating to healthcare. In alternative embodiments, a claim can be a data record (e.g., a file) related to an insurable event such as property (e.g., buildings, vehicles, businesses, and the like). The claim is processed via computing equipment to determine coverage, and possible care decisions. In the alternative, the adjudication on the claim may result in other actions, e.g., rebuilding, legal defense, payout, repair or the like.

As described herein, claim records may include any suitable information associated with processing a primary claim. Generally, claim records include the information within the following categories: (a) definition data; (b) provider data; (c) facility data; (d) insurer data; (e) claim processing data; (f) claim facts data; (g) claimant data; (h) date data; and (i) claim resolution data.

Definition data includes information to define crucial aspects of a particular claim record including, for example, a unique claim identifier, a claim status code, a provider identifier, an insurance identifier, a claimant identifier, a creation date, an update date, a financial amount claimed, and a financial amount approved.

Provider data includes information to identify a particular provider(s) (e.g., provider name(s), identifiers), provider qualifications, provider rate information, and other suitable details.

Facility data includes information to identify the facility in which services are provided (or were provided) including, for example, facility identifier, facility name, facility details, and facility location information.

Insurer data includes information to identify the insurer including, for example, the identifier of the insurance company, the name of the insurance company, and the name of the insurance sub-group, program, or offering associated with the claim.

Claim processing data includes information relevant to the processing of the claim including, for example, the unique claim identifier, a date for the claim (“incurred date”), and a claim processing status.

Claim facts data includes any suitable data related to the details of the claim including, for example, unique claim identifier, fact data related to the financial claims, fact data related to the services rendered, and fact data related to the patient condition or patient illness that necessitated treatment.

Claimant data includes information related to the claimant master record (e.g., a master record containing data related to a particular claimant) including, for example, the full name of the claimant, the address of the claimant, the date of birth of the claimant, unique identifiers for the claimant, the sex and/or gender of the claimant, other claimant details. In some cases, the claimant is not a named policy holder of the primary insurance and is, instead, a beneficiary of a covered policy holder. In such cases, the claimant data may also specify the full name of the policy holder, the address of the policy holder, the date of birth of the policy holder, unique identifiers for the policy holder, the sex and/or gender of the policy holder, the relationship between the policy holder and the claimant, and other policy holder details. However, in many cases such information regarding the claimant or the policy holder is incomplete or inaccurate.

Date data includes time and date records associated with the claim identifying, for example, the date of the incident leading to the claim, the date of the treatment, the date of the filing of the claim, the date of each adjudication (if any), the date of the resolution of the claim (if any), and the date of the payment of the claim (if any).

Claim resolution data includes any information bearing on how the claim has been processed or is being processed including, for example, any adjudications regarding the claim, any dispute, any denial, any elements of the claim that have been withdrawn or terminated, any elements of the claim that have been processed, and any elements of the claim that have been paid.

Claims records or claims data may also include coverage records associated with supplemental insurance policies, and supplemental claim records associated with the claim records. The coverage records define supplemental coverage policies and may include related coverage record data (or “coverage data”) including at least: (a) identifiers for the covered insurance holder, (b) insurer data identifying the insurer, (c) insured and dependent fact data (including, for example, names, addresses, relationships to the insured, and unique identifiers for each), (d) effective date(s) of the insurance, (e) definitions for the supplemental insurance policy including, for example, definitions, coverage limits, coverage terms, coverage deductibles, coverage exclusions, and adjudicatory requirements.

Claims adjudication can include processing the claims data in view of certain applicable rules, algorithms, and/or procedures. Some of these can be defined by an insurance plan, governmental rules, public policy or the like.

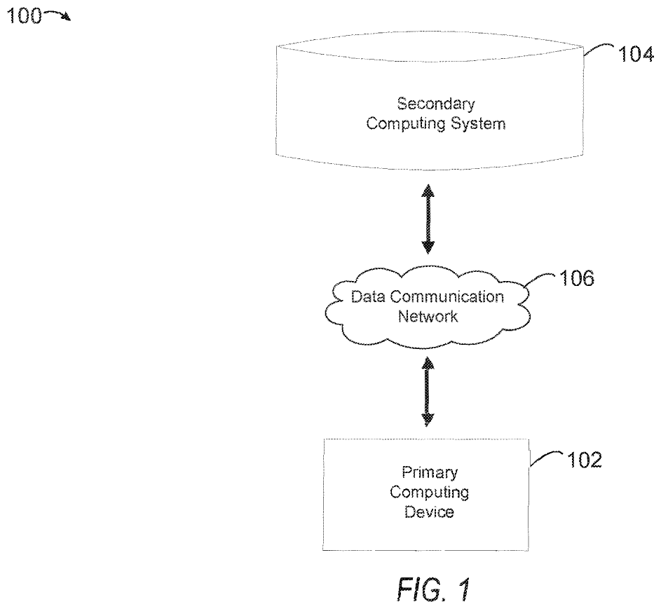

Turning now to the figures, FIG. 1 is a diagram of a system 100 for using generative artificial intelligence (AI) tools in claims adjudication applications, in accordance with the disclosed embodiments. The system 100 includes at least a primary computing device 102 in communication with a secondary computing system 104 via a data communication network 106. In practice, an embodiment of the system 100 may include additional or alternative elements and components, as desired for the particular application. For example, additional components such as display components, user input components, or the like, may be employed without departing from the scope of the present disclosure. The system 100 can generally be implemented in conjunction with any of the embodiments described herein, for example the enhanced processing system 1220 (FIG. 12) and/or claims adjudication process 1300 (FIG. 13). In an embodiment, the system 100 is implemented in logic instructions (e.g., software), configurable logic, fixed-functionality hardware logic, computer readable instructions stored on at least one non-transitory computer readable storage medium that are executable to implement system 100, circuitry, etc., or any combination thereof.

The primary computing device 102 is a device that performs, or contributes to the performance of, claims adjudication in an enterprise computing environment. Relevant claims may include various types of insurance claims (e.g., medical insurance, automobile insurance, life insurance, homeowners' insurance, product purchase insurance), and claims adjudication includes a determination of (i) approval, partial approval, or denial of an insurance claim, and (ii) when approved or partially approved, a payment amount for the insurance claim. Claims adjudication is generally based on predetermined conditions which may be detailed in contracts and other documents, including but not limited to: customer benefit summaries, provider service agreements, or the like. Such insurance claims are intensely rules dependent, data dependent and rules dependent.

The primary computing device 102 may be implemented using any type of computing device that includes at least one processor, some form of memory hardware, and input/output (I/O) mechanisms, and the primary computing device 102 communicates with the secondary computing system 104 via a data communication network 106.

The data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links, or network connections supporting any number of communications protocols. In various embodiments, the data communication network 106 could also incorporate a wireless and/or wired telephone network, such as a cellular communications network for communicating with mobile phones, personal digital assistants, or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

The secondary computing system 104 may be implemented using any number of suitable computers, application servers, or other computing hardware (e.g., circuitry) that includes at least one processor, system memory components, and some form of input/output (I/O). The secondary computing system 104 is operable to store, maintain, and provide access to, various Generative AI tools for use in claims adjudication and/or applications associated with claims adjudication.

During operation, the primary computing device 102 communicates with the secondary computing system 104 to use the Generative AI tools residing on the secondary computing system 104 in claims adjudication applications. The primary computing device 102 transmits data messages to the secondary computing system 104, where the data messages include input data and task completion requests for the Generative AI tools. In response, the secondary computing system 104 initiates operation of the Generative AI tools, produces output via the Generative AI tools, and transmits the output to the primary computing device 102. Input data may include, but is not limited to: contracts associated with a claim (e.g., a customer agreement, a provider service agreement, a benefits summary). Output may include, but is not limited to: results of a claims adjudication process performed by the Generative AI tools and/or executable instructions for use in performing a claims adjudication process outside of the Generative AI tool itself. After receiving the output, the primary computing device 102 uses the output to complete any additional claims adjudication activities that are required by the rules or procedures specific to the enterprise computing environment. In an example, the primary computing device 102 is to adjudicate a claim and the secondary computing device 104 is to use large language models or generative AI to produce code usable by the primary computing device 102 to perform the adjudication functions.

The primary computing device 102 can execute instructions in a method or procedure to evaluate a claim and obtain an initial decision on whether to pay the claim, pay a partial amount of the claim, or to deny the claim. If the initial decision is to pay the claim, then the primary computing device 102 may authorize payment of the claim. If the initial decision is to deny the claim, then the primary computing device 102 can: call an authorization service module; initiate reading, by the authorization service module, the claim and sending the claim to a rules engine; and initiate searching, by the rules engine, whether there are customer facts in a customer facts database and if so then loading by a rules module a set of rules and sending the customer conditions as well as point of sale variables to be evaluated by the rules. The primary computing device 102 then receives an answer, based on the rules evaluation, as to whether an authorization waiver override should be issued; sends the answer to the authorization service module; initiates encoding, by the authorization service module, the answer and sending the answer back to the claim engine; and initiates checking, by the claim engine, for the existence of the authorization waiver override inside the answer. If the authorization waiver override was issued, the primary computing device 102 initiates allowing, by the claim engine, the claim to pay.

The primary computing device 102 can execute instructions in a method or procedure to evaluate a claim for a medical service and obtain an initial decision whether to pay the claim, pay a partial amount of the claim, or to deny the claim. If the initial decision is to pay the claim, then the primary computing device 102 may authorize payment of the claim. If the initial decision is to deny the claim, then the primary computing device 102 can: call an authorization service module; initiate reading, by the authorization service module, the claim and sending the claim to a rules engine; initiate searching, by the rules engine, whether there are customer facts in a customer facts database and if so then loading by a rules module a set of rules and sending the customer conditions as well as point of sale variables to be evaluated by the rules. The primary computing device 102 then receives an answer, based on the rules evaluation, as to whether an authorization waiver override should be issued; sends the answer to the authorization service module; initiates encoding, by the authorization service module, the answer and sending the answer back to the claim engine; and initiates checking, by the claim engine, for the existence of the authorization waiver override inside the answer. If the authorization waiver override was issued, the primary computing device 102 initiates allowing, by the claim engine, the claim to pay.

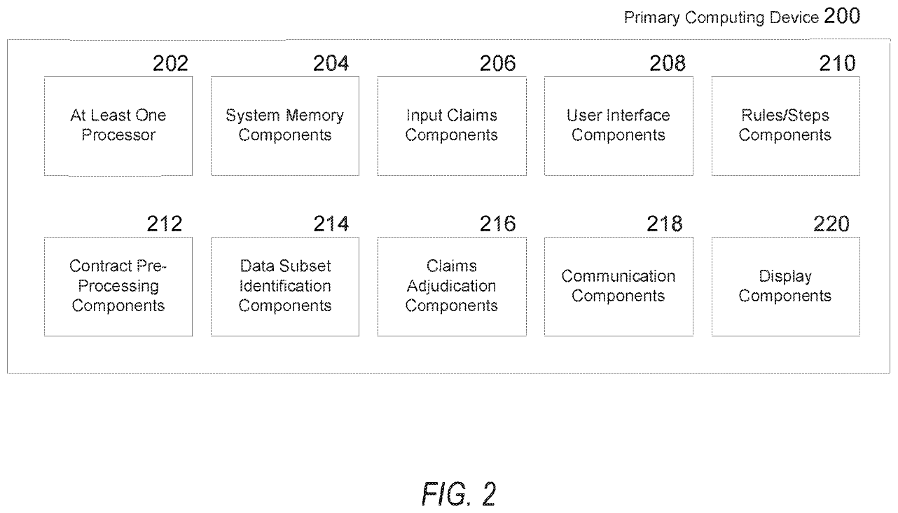

FIG. 2 is a functional block diagram of a primary computing device 200, in accordance with the disclosed embodiments. It should be noted that the primary computing device 200 can be implemented with the primary computing device 102 depicted in FIG. 1. In this regard, the primary computing device 200 shows certain elements and components of the primary computing device 102 in more detail. The primary computing device 200 can generally be implemented in conjunction with any of the embodiments described herein, for example the enhanced processing system 1220 (FIG. 12), claims adjudication process 1300 (FIG. 13), system 100 (FIG. 1). In an embodiment, the primary computing device 200 is implemented in logic instructions (e.g., software), configurable logic, fixed-functionality hardware logic, computer readable instructions stored on at least one non-transitory computer readable storage medium that are executable to implement primary computing device 200, circuitry, etc., or any combination thereof.

The primary computing device 200 generally includes at least one processor 202; system memory components 204; input claims components 206; user interface components 208; rules/steps components 210; contract pre-processing components 212; data subset identification components 214; claims adjudication components 216; communication components 218; and display components 220. These elements and features of the primary computing device 200 may be operatively associated with one another, coupled to one another, or otherwise configured to cooperate with one another as needed to support the desired functionality—in particular, using generative artificial intelligence (AI) tools in claims adjudication applications, as described herein. For case of illustration and clarity, the various physical, electrical, and logical couplings and interconnections for these elements and features are not depicted in FIG. 2. Moreover, it should be appreciated that embodiments of the primary computing device 200 will include other elements, modules, and features that cooperate to support the desired functionality. For simplicity, FIG. 2 only depicts certain elements that relate to the techniques for using of generative AI in claims adjudication applications, described in more detail below.

The at least one processor 202 may be implemented or performed with one or more general purpose processors or processor circuitry, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to the system memory components 204. The system memory components 204 are configured to store any obtained or generated data associated with using generative artificial intelligence (AI) tools in claims adjudication applications. The system memory components 204 may be realized using any number of devices, components, or modules, as appropriate to the embodiment. Moreover, the primary computing device 200 could include system memory components 204 integrated therein and/or system memory components 204 operatively coupled thereto, as appropriate to the particular embodiment. In practice, the system memory components 204 could be realized as RAM memory, flash memory, EPROM memory, EEPROM memory, registers, a hard disk, a removable disk, or any other form of storage medium known in the art. In certain embodiments, the system memory components 204 include a hard disk, which may also be used to support functions of the primary computing device 200. The system memory components 204 can be coupled to the at least one processor 202 such that the at least one processor 202 can read information from, and write information to, any of the system memory components 204. In the alternative, the system memory components 204 may be integral to the at least one processor 202. As an example, the at least one processor 202 and the system memory components 204 may reside in a suitably designed application-specific integrated circuit (ASIC).

The input claims components 206 are operable to obtain one or more claims that require adjudication, and to identify relevant data provided by the claims that is applicable to the claims adjudication procedure. The input claims components 206 may receive or retrieve a claim or set of claims that are currently entering the enterprise computing environment or network associated with the primary computing device 200.

Each claim includes information associated with the type of insurance claim it is and the subject matter for which payment is requested or “claimed”. In some embodiments, a medical insurance claim may include information associated with services provided by a physician, pharmacy, or medical facility. In some embodiments, a homeowners' insurance claim may include information associated with a home repair. In other embodiments, a car insurance claim may include information associated with an automobile repair, or a product insurance claim may include information associated with a repair or replacement of the insured product. Alternative embodiments may include a life insurance claim that includes information associated with a death benefit, or a disability insurance claim that includes information associated with a disability benefit.

The user interface components 208 may include or cooperate with various features to allow a user to interact with the primary computing device 200. Accordingly, the user interface components 208 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the primary computing device 200. For example, the user interface components 208 could be manipulated by an operator to initiate the use of Generative Artificial Intelligence (AI) tools as part of a claims adjudication procedure, as described herein. As another example, the user interface components 208 could be manipulated by an operator to adjust claims or the rules applied to claim adjudication. As another example, the user interface components 208 could be manipulated by an operator to correct the predictive model from the AI system or output from the AI system.

In certain embodiments, the user interface components 208 may include or cooperate with various features to allow a user to interact with the primary computing device 200 via graphical elements rendered on one or more display components 220 (e.g., a display device). Accordingly, the user interface components 208 may initiate the creation, maintenance, and presentation of a graphical user interface (GUI). In certain embodiments, the display components 220 implement touch-sensitive technology for purposes of interacting with the GUI. Thus, a user can manipulate the GUI by moving a cursor symbol rendered on the display components 220, or by physically interacting with one or more of the display components 220 themselves for recognition and interpretation, via the user interface components 208.

Rules components 210 are operable to retain and apply appropriate procedures, standards, and/or techniques for adjudicating claims. Rules components 210 may be specific to the particular enterprise environment (e.g., industry-specific or company-specific) and may be based on internal policies of a particular organization. Such procedures, standards, and/or techniques may be based on contracts associated with particular types of current input claims. Examples of associated contracts may include, but are not limited to: provider service contracts, customer agreements, benefits summaries, or the like. As described herein, in some embodiments, the rules components 210 may be provided to a Generative AI tool, such that the Generative AI tool is capable of performing claims adjudication operations for claims associated with the enterprise computing system. In some embodiments, the rules components 210 may be provided to a Generative AI tool, such that the Generative AI tool is capable of generating software code that can be executed to perform claims adjudication.

The contract pre-processing components 212 are operable to perform pre-processing operations for one or more contracts associated with an input claim that will be adjudicated. Pre-processing operations may include, but are not limited to: (i) dividing a contract into sections; (ii) converting the sections into numerical representations or vectors; and (iii) storing the vectors in vector database for use in claims adjudication applications.

The data subset identification components 214 are operable to classify services indicated by an input claim, and to identify and locate relevant sections of a contract (e.g., an unstructured data file) associated with the input claim, for purposes of claims adjudication. The data subset identification components 214 identify a service that is included in the input claim that will be adjudicated, and convert the identified service to a numerical representation or vector. The data subset identification components 214 are further operable to evaluate a vector database that includes stored vectors associated with sections of applicable contracts, and to identify a vector in the vector database that corresponds to the vector of the service indicated by the input claim. In certain embodiments, the data subset identification components 214 are also operable to extract a section of the contract associated with the corresponding vector.

The claims adjudication components 216 are operable to perform claims adjudication procedures based on the information provided by the rules components 210. In some embodiments, the claims adjudication components 216 are further operable to transmit a request to one or more selected Generative AI tools to perform the claims adjudication procedures using provided rules and input data (contracts, new current claim(s)). In some embodiments, the claims adjudication components 216 are also operable to request Generative AI tools to provide dynamically generated executable instructions instead of performing claims adjudication procedures directly.

In practice, the input claims components 206, the user interface components 208, the rules/steps components 210, the contract pre-processing components 212, the data subset identification components 214, and/or the claims adjudication components 216 may be implemented with (or cooperate with) the at least one processor 202 to perform at least some of the functions and operations described in more detail herein. In this regard, the input claims components 206, the user interface components 208, the rules/steps components 210, the contract pre-processing components 212, the data subset identification components 214, and/or the claims adjudication components 216 may be realized as suitably written processing logic, application program code, or the like.

The communication components 218 are suitably configured to communicate data between the primary computing device 200 and a secondary computing system (as shown in FIG. 1, reference 104) that is operable to store, maintain, and provide access to, various generative AI tools for use in claims adjudication and/or applications associated with claims adjudication. Certain embodiments of the communication components 218 may also be configured to transmit and receive communications between the primary computing device 200 and other external computing devices (e.g., a personal computing device, a server, external computer storage, or the like). The communication components 218 may transmit and receive communications over a wireless local area network (WLAN), the Internet, a satellite uplink/downlink, a cellular network, a broadband network, a wide area network, or the like. As described in more detail herein, data received by the communication components 218 may include, without limitation: output of Generative AI tools, executable instructions associated with claims adjudication, claims adjudication results, and other data compatible with the primary computing device 200. Data provided by the communication components 218 may include, without limitation: training data for Generative AI tools, input data for a Generative AI tool request, and/or requests for analysis performed by Generative AI tools, and the like.

The display components 220 are configured to display, render, or otherwise convey various images, icons, text, and/or graphical elements or representations associated with generative artificial intelligence (AI) tools, claims adjudication, or the like. The display components 220 may be implemented as one or more computer monitors, computer screens (including touchscreens), audio/video presentation screens, video display units (VDUs), televisions, and/or any other presentation devices communicatively coupled to (or integrated into) the primary computing device 200. In certain embodiments, the display components 220 may be realized as a display screen of a standalone, personal computing device (e.g., laptop computer, tablet computer). In other embodiments, the display components 220 may be implemented as one or more external electronic displays communicatively coupled to the primary computing device 200 via a wired or wireless connection. It will be appreciated that although the display components 220 may be implemented using a single display, certain embodiments may use additional displays (i.e., a plurality of displays) to accomplish the functionality of the display components 220 described herein.

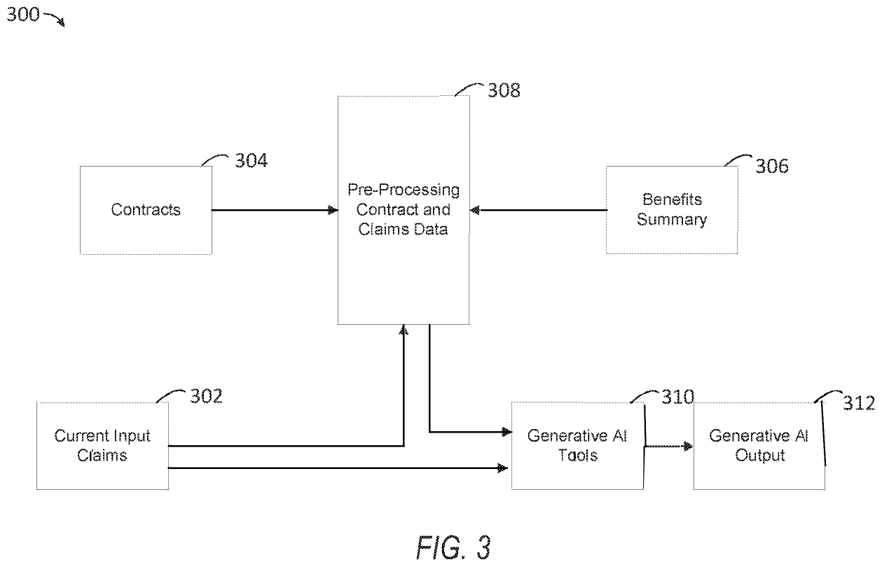

FIG. 3 is a diagram of communications in a system 300 for using generative AI tools in claims adjudication applications, in accordance with the disclosed embodiments. The system 300 can generally be implemented in conjunction with any of the embodiments described herein, for example the enhanced processing system 1220 (FIG. 12), claims adjudication process 1300 (FIG. 13), system 100 (FIG. 1) and/or primary computing device 200 (FIG. 2). In an embodiment, the system 300 is implemented in logic instructions (e.g., software), configurable logic, fixed-functionality hardware logic, computer readable instructions stored on at least one non-transitory computer readable storage medium that are executable to implement system 300, circuitry, etc., or any combination thereof.

Current input claims 302, various contracts 304 and benefits summaries 306 associated with the current input claims 302, are input data for pre-processing 308.

Current input claims 302 and output of pre-processing 308 are input data for one or more Generative AI tools 310, which produces Generative AI output 312.

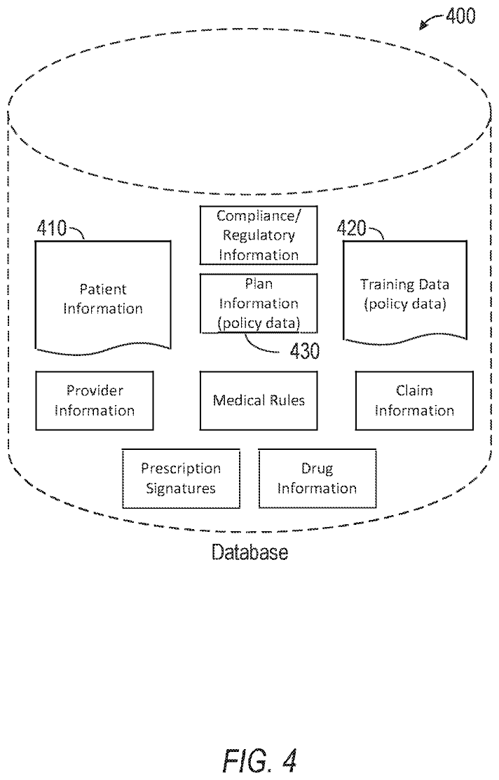

FIG. 4 shows a database 400 of inputs that can be used in the present systems and methods, according to some examples. The database 400 can generally be implemented in conjunction with any of the embodiments described herein, for example the enhanced processing system 1220 (FIG. 12), claims adjudication process 1300 (FIG. 13), system 100 (FIG. 1), primary computing device 200 (FIG. 2) and/or system 300 (FIG. 3). In an embodiment, the database 400 is implemented in logic instructions (e.g., software), configurable logic, fixed-functionality hardware logic, computer readable instructions stored on at least one non-transitory computer readable storage medium that are executable to implement database 400, circuitry, etc., or any combination thereof.

The database 400 includes patient information 410 and training data 420. The patient information 410 can be generated or accessed by a patient management platform. For example, the patient management platform can access one or more patient records from one or more sources, including pharmacy claims, benefit information, prescribing physician information, dispensing information (e.g., where and how the patient obtains their current medications), medicinal drug prescriptions, prescription signatures, demographic information, prescription information including dose quantity and interval, medical provider data, and input from a patient received via a user interface presented on the client device and so forth. The patient management platform can collect this information from the patient records and generates a patient features vector that includes this information. Vectors can be inputs into an artificial intelligence engine.

In some examples, the training data 420 includes training sets including collections of textual plan information, e.g., medical coverage requirements, drug plan requirements and the like, or the plan information can be represented in machine readable code that represents the plan requirements. The training data 420 is used to train the machine learning model (e.g., the client requirement models, member enrollment model, or other models dependent on the plan requirements) implemented by the current systems and methods to generate predictive models to interpret policy requirements for enrollment or benefit interpretation on a predictive basis.

In some examples, the training data 420 includes training sets including collections of policies from multiple documents, inclusive of current contracts of the actual healthcare entity, changes to the policies, future policies changes or the like relating to healthcare. These can be represented as fixed requirements and the healthcare issues can be vectors in the machine learning engine for a large language model.

In some examples, the present methods and systems can use historical policy databases to generate the training data 420.

The plan information (policy data) 430 is current plan information or anticipated changes to a policy, e.g., via written documentation. This plan information 430 can be collections of textual plan information, e.g., medical coverage requirements, drug plan requirements and the like, or the plan information can be represented in machine readable code that represents the plan requirements. The plan information 430 is used to update the machine learning model (e.g., the client requirement models, member enrollment model, or other models dependent on the plan requirements) implemented by the current systems and methods to interpret policy requirements for enrollment or benefit interpretation on a predictive basis.

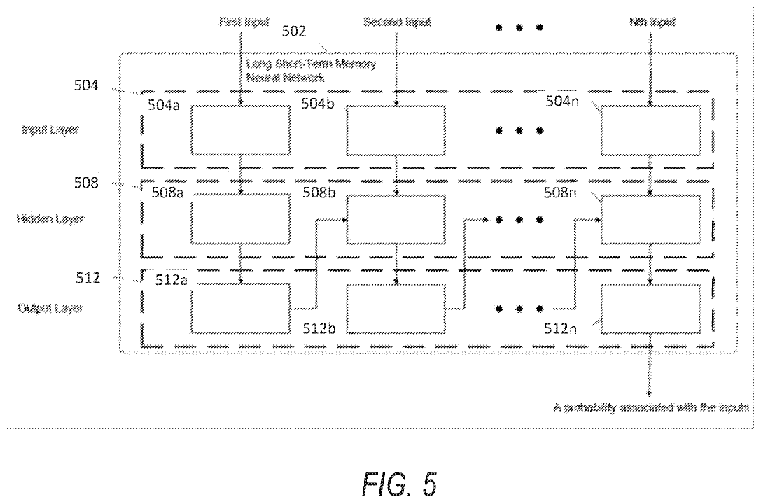

FIG. 5 is a functional block diagram of an example neural network 502 that can be used for the inference engine or other functions (e.g., AI engines) as described herein to produce a predictive model.

The neural network 502 can generally be implemented in conjunction with any of the embodiments described herein, for example the enhanced processing system 1220 (FIG. 12), claims adjudication process 1300 (FIG. 13), system 100 (FIG. 1), primary computing device 200 (FIG. 2), system 300 (FIG. 3) and/or database 400 (FIG. 4). In an embodiment, the neural network 502 is implemented in logic instructions (e.g., software), configurable logic, fixed-functionality hardware logic, computer readable instructions stored on at least one non-transitory computer readable storage medium that are executable to implement neural network 502, circuitry, etc., or any combination thereof.

The predictive model can identify or generate effects of policy requirements and/or policy changes relating to healthcare. In an example, the neural network 502 can be a LSTM neural network. In an example, the neural network 502 can be a recurrent neural network (RNN). The example neural network 502 may be used to implement the machine learning as described herein, and various implementations may use other types of machine learning networks. The neural network 502 includes an input layer 504, a hidden layer 508, and an output layer 512. The input layer 504 includes inputs 504a, 504b . . . 504n. The hidden layer 508 includes neurons 508a, 508b . . . 508n. The output layer 512 includes outputs 512a, 512b . . . 512n.

Each neuron of the hidden layer 508 receives an input from the input layer 504 and outputs a value to the corresponding output in the output layer 512. For example, the neuron 508a receives an input from the input 504a and outputs a value to the output 512a. Each neuron, other than the neuron 508a, also receives an output of a previous neuron as an input. For example, the neuron 508b receives inputs from the input 504b and the output 512a. In this way the output of each neuron is fed forward to the next neuron in the hidden layer 508. The last output 512n in the output layer 512 outputs a probability associated with the inputs 504a-504n. Although the input layer 504, the hidden layer 508, and the output layer 512 are depicted as each including three elements, each layer may contain any number of elements. Neurons can include one or more adjustable parameters, weights, rules, criteria, or the like.

In various implementations, each layer of the neural network 502 must include the same number of elements as each of the other layers of the neural network 502. For example, training features (e.g., collection of textual policy requirements associated with a first set of policies may be processed to create the inputs 504a-504n.

The neural network 502 may implement a first model to produce one or more policy requirements for a first type of contract, a first type of client, and/or a first type of member. More specifically, the inputs 504a-504n can include fields of the policy as data features (binary, vectors, factors or the like) stored in the storage device, e.g., database 400. The features of the policy can be provided to neurons 508a-508n for analysis and connections between the known facts. The neurons 508a-508n, upon finding connections, provides the potential connections as outputs to the output layer 512, which determines a set of effects associated with the policy.

The neural network 502 may implement a second model to that is a refinement of the first model. More specifically, the inputs 504a-504n can include changes to the model or inputs from outputs when using the first model. The second model can be produced using data features (binary, vectors, factors or the like) stored in the storage device, e.g., database 400. The features of the entities can be provided to neurons 508a-508n for analysis and connections between the known facts. The neurons 508a-508n, upon finding connections, provides the potential connections as outputs to the output layer 512, which determines the updated set of effects by a policy.

The neural network 502 can perform any of the above calculations. The output of the neural network 502 can be used to trigger display of a prompt that includes the medical signature to an operator in a GUI. For example, the prompt (e.g., notification) can be provided to a PBM, health plan manager, pharmacy, physician, caregiver, and/or a patient. The prompt can include the original contract or policy.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 504a is connected to each of neurons 508a, 508b . . . 508n.

The initial model that is built can be built in a secure environment using policy data relating to patients. The initial model can then be refined based on feedback with a computing system that also is in a secure environment. The health data and policy are always within a secure computing environment and not communicated out to a public database and subjected to a third-party artificial intelligence. The secure computing system mitigates the risk of working with protected health data and other types of high-risk data, e.g., personal identifying information, state protected data, or other proprietary data. In an example, the secure computing system is a mainframe computer with limited connection to external systems. In an example, the computing system is a private cloud environment that provides high-performance, secure, and flexible computing environments enabling the analysis of sensitive datasets restricted by federal privacy laws, proprietary access agreements, or confidentiality requirements. A private cloud environment can provide creation of any combination of network, CPU, RAM, and storage components into resource groups that can be used to build multi-tenant, multi-site infrastructure as a service.

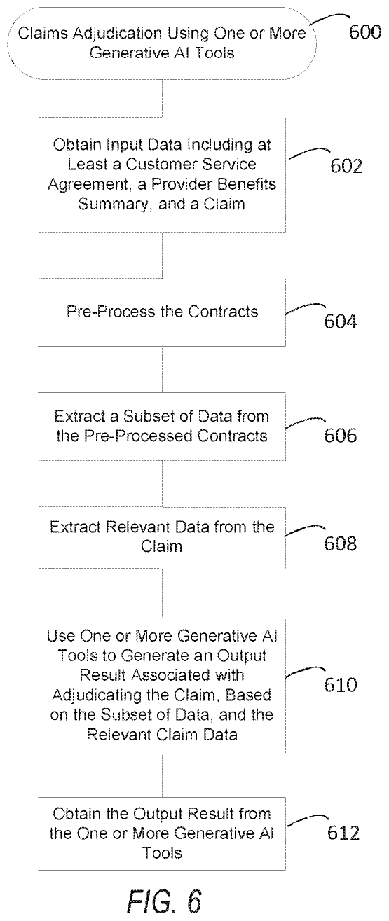

FIG. 6 is a flow chart that illustrates an embodiment of a process 600 for using generative AI tools in claims adjudication applications, according to the disclosed embodiments. The process 600 can generally be implemented in conjunction with any of the embodiments described herein, for example the enhanced processing system 1220 (FIG. 12), claims adjudication process 1300 (FIG. 13), system 100 (FIG. 1), primary computing device 200 (FIG. 2), system 300 (FIG. 3), database 400 (FIG. 4) and/or neural network 502 (FIG. 5). In an embodiment, the process 600 is implemented in logic instructions (e.g., software), configurable logic, fixed-functionality hardware logic, computer readable instructions stored on at least one non-transitory computer readable storage medium that are executable to implement process 600, circuitry, etc., or any combination thereof.

The process 600 obtains a current input claim associated with claims adjudication, by a primary computing device via communication components (step 602).

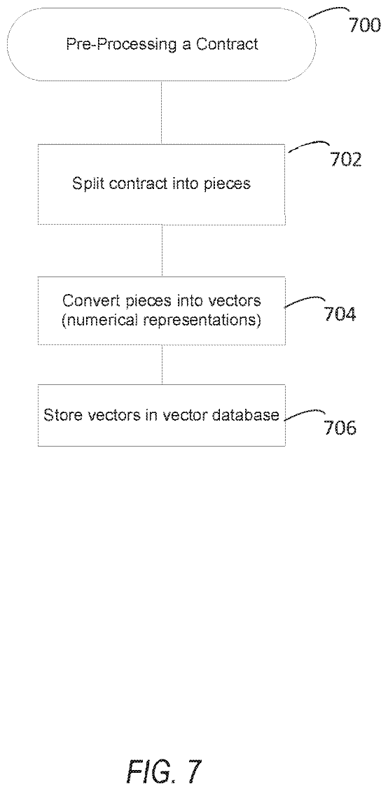

The process 600 pre-processes one or more contracts associated with the current input claim, by the primary computing device, to generate one or more pre-processed contracts, wherein the one or more contracts includes at least one of: a provider service agreement and a customer benefits summary (step 604). One suitable methodology for pre-processing the one or more contracts is described below with reference to FIG. 7.

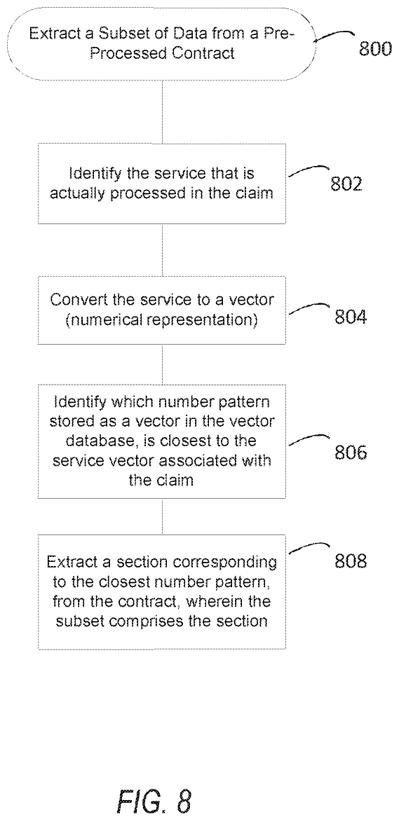

The process 600 extracts a subset of contract data from the one or more pre-processed contracts, by the primary computing device (step 606). One suitable methodology for extracting the subset of contract data from the one or more pre-processed contracts is described below with reference to FIG. 8.

The process 600 extracts relevant data from the current input claim, by the primary computing device (step 608).

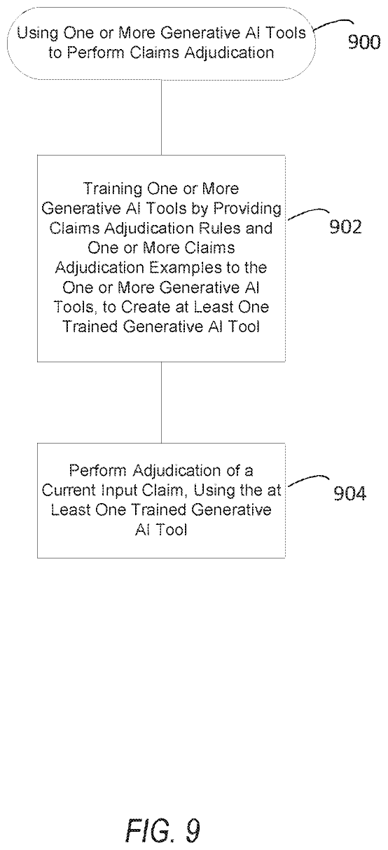

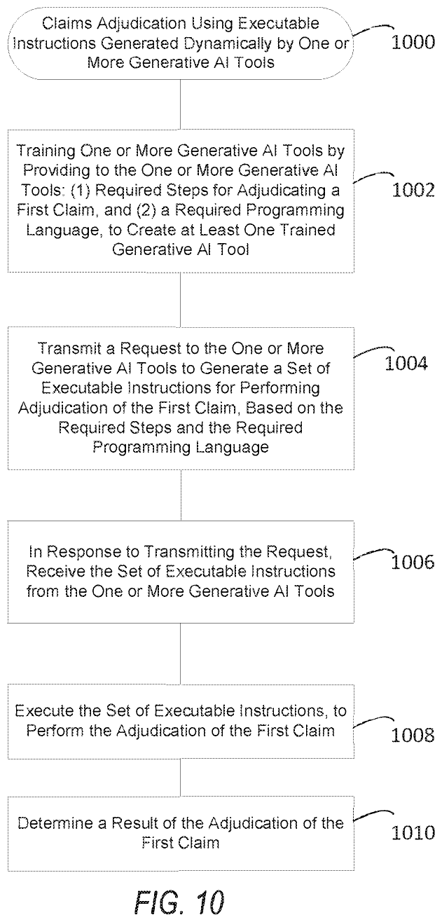

The process 600 uses one or more Generative Artificial Intelligence (AI) tools to generate an output result associated with adjudicating the current input claim, based on the subset of data and the relevant claim data (step 610). Suitable methodologies for uses one or more Generative AI tools to generate an output result are described below with reference to FIGS. 9 and 10.

The process 600 obtains the output result from the one or more Generative AI tools, by the primary computing device via the communication components (step 612).

FIG. 7 is a flow chart that illustrates an embodiment of a process 700 for pre-processing a contract, according to the disclosed embodiments. It should be appreciated that process 700 is one exemplary embodiment of step 604 of FIG. 6, including additional detail. In an embodiment, the process 700 is implemented in logic instructions (e.g., software), configurable logic, fixed-functionality hardware logic, computer readable instructions stored on at least one non-transitory computer readable storage medium that are executable to implement process 700, circuitry, etc., or any combination thereof.

The process 700 divides the one or more contracts into contract parts, by the primary computing device (step 702).

The process 700 converts the contract parts into vectors, by the primary computing device, wherein each of the vectors comprises a numerical representation of one of the contract parts (step 704).

The process 700 stores the vectors in a vector database for use during the claims adjudication, by the primary computing device (step 706).

FIG. 8 is a flow chart that illustrates an embodiment of a process 800 for extracting a subset of data from a pre-processed contract, according to the disclosed embodiments. It should be appreciated that process 800 is one exemplary embodiment of step 606 of FIG. 6, including additional detail. In an embodiment, the process 800 is implemented in logic instructions (e.g., software), configurable logic, fixed-functionality hardware logic, computer readable instructions stored on at least one non-transitory computer readable storage medium that are executable to implement process 800, circuitry, etc., or any combination thereof.

The process 800 identifies a service associated with the current input claim, by the primary computing device, wherein the current input claim includes an indication of the service (step 802).

The process 800 converts the indication of the service into a vector, by the primary computing device, wherein the vector comprises a numerical representation of the indication of the service (step 804).

The process 800 compares the vector to a plurality of stored vectors in a vector database, by the primary computing device, wherein the plurality of stored vectors comprises numerical representations of sections of the contract associated with the current input claim; and identifies one of the plurality of stored vectors corresponding to the vector, based on the comparing, by the primary computing device (step 806).

The process 800 identifies the first section of the contract based on the one of the plurality of stored vectors corresponding to the vector, by the primary computing device, wherein the sections of the contract include the first section; and extracts the identified first section of the contract, by the primary computing device, wherein the subset of contract data comprises the identified first section (step 808).

FIG. 9 is a flow chart that illustrates an embodiment of a process 900 for using a generative AI tool to perform claims adjudication, according to the disclosed embodiments. It should be appreciated that process 900 is one exemplary embodiment of step 610 of FIG. 6, including additional detail. The process 900 can generally be implemented in conjunction with any of the embodiments described herein, for example the enhanced processing system 1220 (FIG. 12), claims adjudication process 1300 (FIG. 13), system 100 (FIG. 1), primary computing device 200 (FIG. 2), system 300 (FIG. 3), database 400 (FIG. 4), neural network 502 (FIG. 5), process 600 (FIG. 6), process 700 (FIG. 7) and/or process 800 (FIG. 8). In an embodiment, the process 900 is implemented in logic instructions (e.g., software), configurable logic, fixed-functionality hardware logic, computer readable instructions stored on at least one non-transitory computer readable storage medium that are executable to implement process 900, circuitry, etc., or any combination thereof.

The process 900 trains the one or more Generative AI tools by providing claims adjudication rules and one or more claims adjudication examples, to create at least one trained Generative AI tool, by the primary computing device (step 902).

The process 900 performs adjudication of the current input claim, using the at least one trained Generative AI tool, by the primary computing device (step 904).

FIG. 10 is a flow chart that illustrates an embodiment of a process 1000 for using a generative AI tool to dynamically generate executable instructions for performing claims adjudication, according to the disclosed embodiments. It should be appreciated that process 1000 is one exemplary embodiment of step 610 of FIG. 6, including additional detail. In an embodiment, the process 1000 is implemented in logic instructions (e.g., software), configurable logic, fixed-functionality hardware logic, computer readable instructions stored on at least one non-transitory computer readable storage medium that are executable to implement process 1000, circuitry, etc., or any combination thereof.

The process 1000 trains the one or more Generative AI tools by providing to the one or more Generative AI tools: (i) required steps for adjudicating a first claim, and (ii) a required programming language, to create at least one trained Generative AI tool (step 1002).

The process 1000 transmits a request to the one or more Generative AI tools to generate a set of executable instructions for performing adjudication of the first claim, based on the required steps and the required programming language (step 1004).

The process 1000 in response to transmitting the request, receiving the set of executable instructions from the one or more Generative AI tools, wherein the output result comprises the set of executable instructions (step 1006).

The process 1000 executes the set of executable instructions, to perform the adjudication of the first claim, by the primary computing device (step 1008).

The process 1000 determines a result of the adjudication of the first claim, by the primary computing device (step 1010).

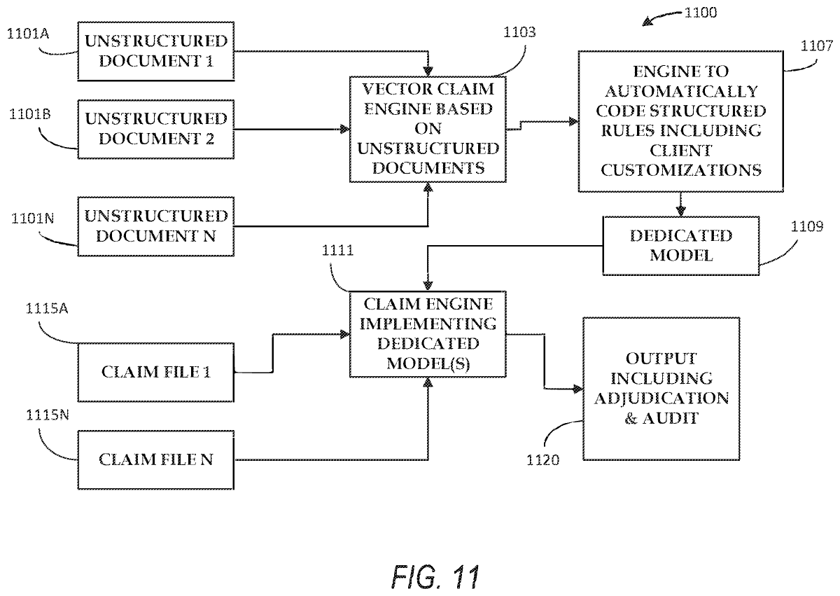

FIG. 11 shows a functional block diagram 1100 of a system for automatically generating code from unstructured data files to be used to process individual claim files. A plurality of unstructured data files 1101A-1101N are fed to a vector claim engine 1103. The functional block diagram 1100 can generally be implemented in conjunction with any of the embodiments described herein, for example the enhanced processing system 1220 (FIG. 12), claims adjudication process 1300 (FIG. 13), system 100 (FIG. 1), primary computing device 200 (FIG. 2), system 300 (FIG. 3), database 400 (FIG. 4), neural network 502 (FIG. 5), process 600 (FIG. 6), process 700 (FIG. 7), process 800 (FIG. 8), process 900 (FIG. 9) and/or process 1000 (FIG. 10). In an embodiment, the process 900 is implemented in logic instructions (e.g., software), configurable logic, fixed-functionality hardware logic, computer readable instructions stored on at least one non-transitory computer readable storage medium that are executable to implement process 900, circuitry, etc., or any combination thereof.

The vector claim engine 1103 individually processes the plurality of unstructured data files 1101A-1101N to derive rules from the unstructured data files. In an example, the unstructured data files 1101A-1101N are client benefit summaries that establish the benefit rules for the members covered by the client. The vector claim engine can transform the unstructured data files 1101A-1101N into structured data. In an example, the structured data can include the benefits data, copay data, deductible data, coinsurance data, minimum age data, maximum age data, riders, specialty data and the like. The structured data is fed to an automated coding engine 1107 that automatically generates machine code based on the structured data to produce a dedicated model 1109. The model 1109 is a machine executable code that represents an automated way to process claims. The engines 1103, 1107 can use generative AI to structure the unstructured data and then automatically generate machine operatable code. The dedicated model includes the code for each unstructured document.

A claim processing engine 1111 loads the dedicated models 1109 and selects the appropriate model based on the claim file received from the plurality of claim files 1115A-1115N. In an example, only one model is used to process the claim. The claim file related to an individual that is covered under one of the unstructured documents 1101A-1101N associated with a particular entity. The claim engine 1111 outputs a claim adjudication and an audit file 1120 of how the claim file was processed. In an example, the claim file 1115 is structured data in contrast to the unstructured document. In an example, the structured data can include the benefits data, copay data, deductible data, coinsurance data, minimum age data, maximum age data, riders, specialty data and the like.

In an example, the system uses generative AI to generate code from the unstructured document, while not using generative AI to process the claim file. This can operate to ensure that the processing of the claim file is not subject to changes or hallucinations by the generative AI being used.

In an embodiment, the use of coded rules outputs an audit trail of exactly how the application of the rules from the unstructured document are applied.

The present system has been able to process 20% more claims than traditional claims processing. It is believed that the use of the engine to convert the unstructured data, e.g., from a contract, to structured data is a factor in this improvement. The present inventor has further found that the use of the generative AI engine both to identify the rules from the unstructured document and to write machine code for automating the claims processing does not significantly slow down the setup procedure for automated claims processing. The present methodology further streamlines entry of the rules into the claims processing system. The rules generation is individualized and all of the rules are in a single model for a single client. In some traditional claims processing, multiple systems are used to set up a claims process. Each of these multiple systems must have its data and rules when a claim arrives. As an example, if there are ten systems that store data for claim processing, each of the ten systems must be up to date, accurate and available to each successive system to process the claim.

The use of the vector claim engine directly processing the source of truth unstructured document can reduce the chance for errors. In contrast, some traditional claims processing relies on data from multiple systems and sources to process a claim. In some of the present embodiments, there is a single source of truth document and a single machine executable model corresponding to the single source of truth document.

In various embodiments, generative AI is used only to read the unstructured data and generate structured data than the generative AI engine can write rule for the claim processing engine to process claims. The claims processing engine does not use generative AI or large language models.

The various tasks performed in connection with processes 600-1000 may be performed by software, hardware, firmware, or any combination thereof. For illustrative purposes, the preceding descriptions of processes 600-1000 may refer to elements mentioned above in connection with FIGS. 1-5. In practice, portions of processes 600-1000 may be performed by different elements of the described system. It should be appreciated that processes 600-1000 may include any number of additional or alternative tasks, the tasks shown in FIGS. 6-10 need not be performed in the illustrated order, and processes 600-1000 may be incorporated into a more comprehensive procedure or process having additional functionality not described in detail herein. Moreover, one or more of the tasks shown in FIGS. 6-10 could be omitted from embodiments of one or more of the processes 600-1000 as long as the intended overall functionality remains intact.

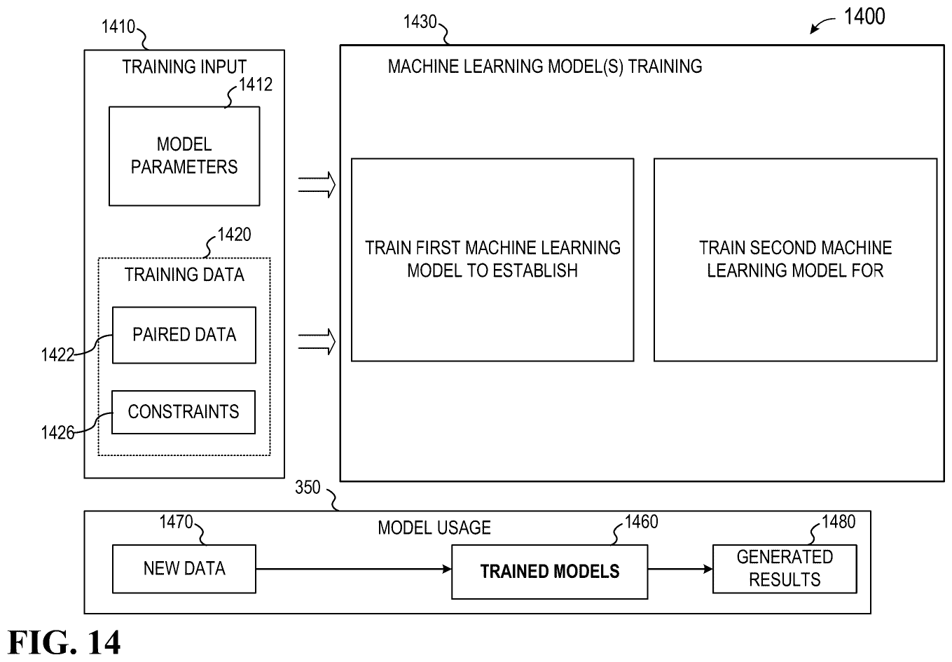

FIG. 14 is a block diagram 1400 of an example service of enhanced teleservice process/system training input 1410 can be deployed within enhanced processing system 1220 (FIG. 12), claims adjudication process 1300 (FIG. 13), system 100 (FIG. 1), primary computing device 200 (FIG. 2), system 300 (FIG. 3), database 400 (FIG. 4), neural network 502 (FIG. 5), process 600 (FIG. 6), process 700 (FIG. 7), process 800 (FIG. 8), process 900 (FIG. 9) and/or process 1000 (FIG. 10). In an embodiment, the training input 1410 is implemented in logic instructions (e.g., software), configurable logic, fixed-functionality hardware logic, computer readable instructions stored on at least one non-transitory computer readable storage medium that are executable to implement training input 1410, circuitry, etc., or any combination thereof.

Training input 1410 includes model parameters 1412 and training data 1420, which may include paired training data sets 1422 (e.g., input-output training pairs) and constraints 1426. Model parameters 1412 store or provide the parameters or coefficients of corresponding ones of machine learning models. During training, these parameters 1412 are adapted based on the input-output training pairs of the training data sets 1422. After the parameters 1412 are adapted (after training), the parameters are used by trained models 1460 to implement the trained machine learning models on a new set of data 1470 of model usage 350.

Training data 1420 includes constraints 1426 which may define the constraints of a given patient information features. The paired training data sets 1422 may include sets of input-output pairs, such as pairs of a plurality of structured data and code. Some components of training input 1410 may be stored separately at a different off-site facility or facilities than other components.

Machine learning model(s) training 1430 trains one or more machine learning techniques based on the sets of input-output pairs of paired training data sets 1422. For example, the model training 1430 may train the machine learning (ML) model parameters 1412 by minimizing a loss function. The ML model can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, an LLM, a generative network, a diffusion model, and the like.

Particularly, the ML model can be applied to a training batch of structured data and code from unstructured data features. In some implementations, a derivative of a loss function is computed based on a comparison of the preliminary structured data and code and the ground truth data and parameters of the ML model are updated based on the computed derivative of the loss function.

The result of minimizing the loss function for multiple sets of training data trains, adapts, or optimizes the model parameters 1412 of the corresponding ML models. In this way, the ML model is trained to establish a relationship between unstructured data and structured data and code.

After the machine learning model is trained, new data 1470 can be provided. The trained machine learning model may be applied to the new data 1470 to generate results 1480 including code and structured data. The code and structured data can be represented in a GUI, such as in a prompt overlaid on the GUI allowing a programmer to selectively include, modify and/or adjust portions of the code and structured data.

The present disclosure can operate on at least one healthcare related contract from which the data can be extracted by the Artificial Intelligence (AI) tools. The AI tools can identify one or more sections of the contract and within each section identify data (e.g., terms) within the identified one or more sections of the contract that is meaningful for claims adjudication. In an example, the language in the contract can be initially turned into digital data by a natural language processing (NLP) engine. The adjudication data can include clauses, obligations, time data, drug data, provider data, unstructured data, and tabular data. In an example a prefilter engine can identify the section prior to the AI tools identifying the terms. In an example, the one or more sections are identified using a predefined library of sections. The identified one or more sections are tagged as to section type before using the Artificial Intelligence (AI) methodologies described herein.

The present disclosure uses the term contract to explain various embodiments. A contract can be an unstructured data file that contains multiple data types and multiple data values in the multiple data types.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The AI and ML models can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, and the like.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematics shown in FIGS. 1-5 depict exemplary arrangements of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

For purposes of the present disclosure, embodiments described herein may include additional components, elements, or features that cooperate to support the desired functionality. Such additional components, elements, or features may include duplicates. Thus, as described herein, “a” component, “an” element or “a” feature may indicate one, or more than one, of the component, element, or feature.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computing system for comprising:
a processor; and
a memory having a set of instructions, which when executed by the processor, cause the computing system to:
identify an input request associated with a plurality of automatic processes;
pre-process, with a first machine learning model, user data associated with the input request to generate first executable program code and a first data structure containing a part of the user data;
generate an output to execute the first executable program code based on the first data structure and the input request;
select a first automatic process from the plurality of automatic processes based on the output; and
execute the first automatic process based on the first automatic process being selected.

2. The computing system of claim 1, wherein the instructions of the memory, when executed by the processor, cause the computing system to:
divide the user data into user parts; and
convert the user parts into vectors, wherein each of the vectors comprises a numerical representation of one of the user parts;
wherein to pre-process, with the first machine learning model, the user data, the instructions of the memory, when executed by the processor, cause the computing system to generate the first executable program code and the first data structure based on the vectors.

3. The computing system of claim 1, wherein the instructions of the memory, when executed by the processor, cause the computing system to:
pre-process, with a second machine learning model, entity data associated with the input request to generate second executable program code and a second data structure containing part of the entity data, wherein the entity data is associated with the first automatic process; and
execute the second executable program code based on the second data structure and the input request;
wherein to generate the output, the instructions of the memory, when executed by the processor, cause the computing system generate the output based on the execution of the second executable program code.

4. The computing system of claim 1, wherein the instructions of the memory, when executed by the processor, cause the computing system to:
update, with the first machine learning model, the user data and the first executable program code based on a modification to the user data.

5. The computing system of claim 1, wherein the user data is unstructured data, and the first data structure is structured data.

6. The computing system of claim 1, wherein the first machine learning model is a generative artificial intelligence model.

7. The computing system of claim 1, wherein:
the input request is a request to process a claim, and
the plurality of automatic processes includes an automatic rejection of the claim and an automatic acceptance of the claim.

8. A method comprising:
identifying an input request associated with a plurality of automatic processes;
pre-processing, with a first machine learning model, user data associated with the input request to generate first executable program code and a first data structure containing a part of the user data;
generating an output by executing the first executable program code based on the first data structure and the input request;
selecting a first automatic process from the plurality of automatic processes based on the output; and
executing the first automatic process based on the first automatic process being selected.

9. The method of claim 8, further comprising:
dividing the user data into user parts; and
converting the user parts into vectors, wherein each of the vectors comprises a numerical representation of one of the user parts;
wherein the pre-processing includes generating the first executable program code and the first data structure based on the vectors.

10. The method of claim 8, further comprising:
pre-processing, with a second machine learning model, entity data associated with the input request to generate second executable program code and a second data structure containing part of the entity data, wherein the entity data is associated with the first automatic process; and
executing the second executable program code based on the second data structure and the input request;
wherein the generating the output includes generating the output based on the execution of the second executable program code.

11. The method of claim 8, further comprising:
updating, with the first machine learning model, the user data and the first executable program code based on a modification to the user data.

12. The method of claim 8, wherein the user data is unstructured data, and the first data structure is structured data.

13. The method of claim 8, wherein the first machine learning model is a generative artificial intelligence model.

14. The method of claim 8, wherein:
the input request is a request to process a claim, and
the plurality of automatic processes includes an automatic rejection of the claim and an automatic acceptance of the claim.

15. At least one non-transitory computer readable storage medium comprising a set of instructions, which when executed by a computing system, cause the computing system to:
identify an input request associated with a plurality of automatic processes;
pre-process, with a first machine learning model, user data associated with the input request to generate first executable program code and a first data structure containing a part of the user data;
generate an output to execute the first executable program code based on the first data structure and the input request;
select a first automatic process from the plurality of automatic processes based on the output; and
execute the first automatic process based on the first automatic process being selected.

16. The at least one non-transitory computer readable storage medium of claim 15, wherein the instructions, when executed, cause the computing system to:
divide the user data into user parts; and
convert the user parts into vectors, wherein each of the vectors comprises a numerical representation of one of the user parts;
wherein to pre-process, with the first machine learning model, the user data, the instructions, when executed, cause the computing system to generate the first executable program code and the first data structure based on the vectors.

17. The at least one non-transitory computer readable storage medium of claim 15, wherein the instructions, when executed, cause the computing system to:
pre-process, with a second machine learning model, entity data associated with the input request to generate second executable program code and a second data structure containing part of the entity data, wherein the entity data is associated with the first automatic process; and
execute the second executable program code based on the second data structure and the input request;
wherein to generate the output, the instructions, when executed, cause the computing system to generate the output based on the execution of the second executable program code.

18. The at least one non-transitory computer readable storage medium of claim 15, wherein the instructions, when executed, cause the computing system to:
update, with the first machine learning model, the user data and the first executable program code based on a modification to the user data.

19. The at least one non-transitory computer readable storage medium of claim 15, wherein the user data is unstructured data, and the first data structure is structured data, and wherein the first machine learning model is a generative artificial intelligence model.

20. The at least one non-transitory computer readable storage medium of claim 15:
the input request is a request to process a claim, and
the plurality of automatic processes includes an automatic rejection of the claim and an automatic acceptance of the claim.
